(19) United States
(12) Patent Application Publication
(10) Pub. No.: US 2026/0247365 A1
(43) Pub. Date: Aug. 20, 2026

(54) GUARD BAND UTILIZATION FOR SIDELINK COMMUNICATIONS

(71) Applicant: QUALCOMM Incorporated, San Diego, CA (US)

(72) Inventors: Luanxia YANG, Beijing (CN); Chih-Hao LIU, San Diego, CA (US); Changlong XU, Beijing (CN); Jing SUN, San Diego, CA (US); Xiaoxia ZHANG, San Diego, CA (US); Shaozhen GUO, Beijing (CN); Siyi CHEN, Beijing (CN)

(21) Appl. No.: 19/489,571

(22) PCT Filed: Jul. 20, 2023
(86) PCT No.: PCT/CN2023/108351

§ 371 Date: Dec. 2, 2025

(51) Int. Cl. H04W 72/0453; H04W 72/25

(52) U.S. Cl. CPC H04W 72/0453; H04W 72/25

(57) ABSTRACT

Methods, systems, and devices for wireless communication are described. An unlicensed sidelink band that includes multiple resource block sets may be used to communicate control information, where a guard band may be positioned in frequency between a first resource block set and a second resource block set of the multiple resource block sets. Based on communicating control information, a control message may be communicated using the first resource block set. The control message may indicate that a portion of the first resource block set and a portion of the guard band have been allocated to a data channel. Based on the control message, a data message may be communicated using resource blocks in the first resource block set and resource block in the guard band.

### CROSS REFERENCE

This Patent Application is a 371 National Stage of PCT Application No. PCT/CN2023/108351, filed on Jul. 20, 2023, and assigned to the assignee hereof. The disclosure of the prior Application is considered part of and is incorporated by reference into this Patent Application.

### FIELD OF TECHNOLOGY

The following relates to wireless communication, including guard band utilization for sidelink communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Wireless communications systems may support communications using licensed spectrum, unlicensed spectrum, or both. Wireless communications systems may also support direct communications between two devices (e.g., two UEs) in the wireless communication system (which may be referred to as sidelink communications). In some examples, wireless communications systems may schedule sidelink communications using resources obtained within unlicensed spectrum.

### SUMMARY

The described techniques relate to improved methods, systems, devices, and apparatuses that support guard band utilization for sidelink communications.

A wireless communications system may support sidelink (SL) communications using an unlicensed band (which may be referred to as SL-U communications). The SL-U communication resources may include resource block sets, where the resource block sets may be separated from one another by intervening guard bands, and where resource blocks within the resource block sets may be assigned to interlaced subchannels. In some examples, multiple sidelink data channels (which may be referred to as PSSCHs) may be scheduled for successive resource block sets. In such cases, resource blocks within the intervening intra-cell guard bands may be left unused. Leaving the intervening intra-cell guard bands unused when multiple sidelink data channels are scheduled across multiple resource block sets may waste communication resources, which may reduce a spectral efficiency of SL-U resources.

Thus, techniques and configurations that enable intra-cell guard band resources to be used when multiple sidelink data channels are scheduled across multiple resource block sets may be desired. As described herein, an indicator of whether resources in an intra-cell guard band next to a resource block set have been allocated to a sidelink data channel may be included in a control message that schedules the sidelink data channel for the resource block set.

A method for wireless communications by a first user equipment (UE) is described. The method may include allocating, to a data channel, at least a portion of a first resource block set of a set of multiple resource block sets in an unlicensed sidelink band and at least a portion of a guard band based on obtaining access to at least a portion of the unlicensed sidelink band that includes the first resource block set, where the guard band is positioned in frequency between a first frequency range of the first resource block set and a second frequency range of a second resource block set of the set of multiple resource block sets and transmitting, based on the allocating, using the first resource block set, a control message for a second UE, the control message indicating that at least the portion of the first resource block set and at least the portion of the guard band have been allocated to the data channel, where resource blocks in the portion of the first resource block set and resource blocks in the portion of the guard band correspond to an interlace indicated in the control message and selected from a set of multiple interlaces.

A first UE for wireless communications is described. The first UE may include one or more memories storing processor executable code, and one or more processors coupled with the one or more memories. The one or more processors may individually or collectively operable to execute the code to cause the first UE to allocate, to a data channel, at least a portion of a first resource block set of a set of multiple resource block sets in an unlicensed sidelink band and at least a portion of a guard band based on obtaining access to at least a portion of the unlicensed sidelink band that includes the first resource block set, where the guard band is positioned in frequency between a first frequency range of the first resource block set and a second frequency range of a second resource block set of the set of multiple resource block sets and transmit, based on the allocating, using the first resource block set, a control message for a second UE, the control message indicating that at least the portion of the first resource block set and at least the portion of the guard band have been allocated to the data channel, where resource blocks in the portion of the first resource block set and resource blocks in the portion of the guard band correspond to an interlace indicated in the control message and selected from a set of multiple interlaces.

Another first UE for wireless communications is described. The first UE may include means for allocating, to a data channel, at least a portion of a first resource block set of a set of multiple resource block sets in an unlicensed sidelink band and at least a portion of a guard band based on obtaining access to at least a portion of the unlicensed sidelink band that includes the first resource block set, where the guard band is positioned in frequency between a first frequency range of the first resource block set and a second frequency range of a second resource block set of the set of multiple resource block sets and means for transmitting, based on the allocating, using the first resource block set, a control message for a second UE, the control message indicating that at least the portion of the first resource block set and at least the portion of the guard band have been allocated to the data channel, where resource blocks in the portion of the first resource block set and resource blocks in the portion of the guard band correspond to an interlace indicated in the control message and selected from a set of multiple interlaces.

A non-transitory computer-readable medium storing code for wireless communications is described. The code may include instructions executable by a processor to allocate, to a data channel, at least a portion of a first resource block set of a set of multiple resource block sets in an unlicensed sidelink band and at least a portion of a guard band based on obtaining access to at least a portion of the unlicensed sidelink band that includes the first resource block set, where the guard band is positioned in frequency between a first frequency range of the first resource block set and a second frequency range of a second resource block set of the set of multiple resource block sets and transmit, based on the allocating, using the first resource block set, a control message for a second UE, the control message indicating that at least the portion of the first resource block set and at least the portion of the guard band have been allocated to the data channel, where resource blocks in the portion of the first resource block set and resource blocks in the portion of the guard band correspond to an interlace indicated in the control message and selected from a set of multiple interlaces.

In some examples of the method, first UEs, and non-transitory computer-readable medium described herein, scheduling, based on obtaining the access, the data channel for at least the portion of the first resource block set and a second data channel for at least a portion of the second resource block set.

In some examples of the method, first UEs, and non-transitory computer-readable medium described herein, at least the portion of the guard band may be allocated to the data channel based on at least the portion of the first resource block set and at least the portion of the second resource block set both being obtained by the first UE.

In some examples of the method, first UEs, and non-transitory computer-readable medium described herein, the control message indicates that at least the portion of the guard band may have been allocated to the data channel based on the guard band being higher in frequency than the first resource block set.

In some examples of the method, first UEs, and non-transitory computer-readable medium described herein, the control message indicates that at least the portion of the first resource block set may have been allocated to the data channel based on being transmitted using the first resource block set.

In some examples of the method, first UEs, and non-transitory computer-readable medium described herein, the control message further indicates an interlace index corresponding to the interlace and a subchannel of the data channel, and one or more resource blocks in the first resource block set corresponding to the subchannel of the data channel and one or more resource blocks in the guard band assigned the interlace index corresponding to the subchannel of the data channel may be allocated to the data channel.

Some examples of the method, first UEs, and non-transitory computer-readable medium described herein may further include operations, features, means, or instructions for transmitting a data message for the second UE using the one or more resource blocks in the first resource block set and the one or more resource blocks in the guard band.

In some examples of the method, first UEs, and non-transitory computer-readable medium described herein, a second guard band may be positioned in frequency between the first resource block set and a third resource block set of the set of multiple resource block sets, the first resource block set positioned in frequency between the second resource block set and the third resource block set, and the control message further indicates whether at least a portion of the second guard band may have been allocated to the data channel.

In some examples of the method, first UEs, and non-transitory computer-readable medium described herein, the control message further indicates an interlace index corresponding to the interlace and a subchannel of the data channel, and one or more resource blocks in the first resource block set corresponding to the subchannel of the data channel, one or more resource blocks in the guard band assigned the interlace index corresponding to the subchannel, and one or more resource blocks in the second guard band assigned the interlace index may be allocated to the subchannel of the data channel.

In some examples of the method, first UEs, and non-transitory computer-readable medium described herein, the control message indicates that at least the portion of the guard band and at least the portion of the second guard band may have been allocated to the data channel and the method, apparatuses, and non-transitory computer-readable medium may include further operations, features, means, or instructions for transmitting a data message for the second UE using one or more resource blocks in the second guard band, one or more resource blocks in the first resource block set, and one or more resource blocks in the guard band.

In some examples of the method, first UEs, and non-transitory computer-readable medium described herein, the control message indicates that at least the portion of the guard band and at least the portion of the second guard band may have been allocated to the data channel and the method, apparatuses, and non-transitory computer-readable medium may include further operations, features, means, or instructions for mapping first data symbols of a data message for the second UE to one or more resource blocks in the first resource block set, second data symbols of the data message to one or more resource blocks in the guard band, and third data symbols of the data message to one or more resource blocks in the second guard band, where the second guard band may be lower in frequency than the first resource block set.

In some examples of the method, first UEs, and non-transitory computer-readable medium described herein, the first data symbols mapped to the one or more resource blocks in the first resource block set may be to be decoded prior to the second data symbols mapped to the one or more resource blocks in the guard band being decoded, and the second data symbols may be to be decoded prior to the third data symbols mapped to the one or more resource blocks in the second guard band being decoded.

In some examples of the method, first UEs, and non-transitory computer-readable medium described herein, the control message indicates that at least the portion of the guard band and at least the portion of the second guard band may have been allocated to the data channel and the method, apparatuses, and non-transitory computer-readable medium may include further operations, features, means, or instructions for mapping first data symbols of a data message for the second UE to one or more resource blocks in the second guard band, second data symbols of the data message to one or more resource blocks in the first resource block set, and third data symbols of the data message to one or more resource blocks in the guard band, where the second guard band may be lower in frequency than the first resource block set.

In some examples of the method, first UEs, and non-transitory computer-readable medium described herein, the first data symbols mapped to the one or more resource blocks in the second guard band may be to be decoded prior to the second data symbols mapped to the one or more resource blocks in the first resource block set being decoded, and the second data symbols may be to be decoded prior to the third data symbols mapped to the one or more resource blocks in the guard band being decoded.

A method for wireless communications by a first user equipment (UE) is described. The method may include receiving, using a first resource block set of a set of multiple resource block sets in an unlicensed sidelink band, a control message for the first UE, the control message indicating that at least a portion of the first resource block set and at least a portion of a guard band have been allocated to a data channel, where the guard band is positioned in frequency between a first frequency range of the first resource block set and a second frequency range of a second resource block set of the set of multiple resource block sets and receiving, based on the control message, a data message using resource blocks in the first resource block set and resource blocks in the guard band, the resource blocks in the first resource block set and the resource blocks in the guard band corresponding to an interlace indicated in the control message and selected from a set of multiple interlaces.

A first UE for wireless communications is described. The first UE may include one or more memories storing processor executable code, and one or more processors coupled with the one or more memories. The one or more processors may individually or collectively operable to execute the code to cause the first UE to receive, using a first resource block set of a set of multiple resource block sets in an unlicensed sidelink band, a control message for the first UE, the control message indicating that at least a portion of the first resource block set and at least a portion of a guard band have been allocated to a data channel, where the guard band is positioned in frequency between a first frequency range of the first resource block set and a second frequency range of a second resource block set of the set of multiple resource block sets and receive, based on the control message, a data message using resource blocks in the first resource block set and resource blocks in the guard band, the resource blocks in the first resource block set and the resource blocks in the guard band corresponding to an interlace indicated in the control message and selected from a set of multiple interlaces.

Another first UE for wireless communications is described. The first UE may include means for receiving, using a first resource block set of a set of multiple resource block sets in an unlicensed sidelink band, a control message for the first UE, the control message indicating that at least a portion of the first resource block set and at least a portion of a guard band have been allocated to a data channel, where the guard band is positioned in frequency between a first frequency range of the first resource block set and a second frequency range of a second resource block set of the set of multiple resource block sets and means for receiving, based on the control message, a data message using resource blocks in the first resource block set and resource blocks in the guard band, the resource blocks in the first resource block set and the resource blocks in the guard band corresponding to an interlace indicated in the control message and selected from a set of multiple interlaces.

A non-transitory computer-readable medium storing code for wireless communications is described. The code may include instructions executable by a processor to receive, using a first resource block set of a set of multiple resource block sets in an unlicensed sidelink band, a control message for the first UE, the control message indicating that at least a portion of the first resource block set and at least a portion of a guard band have been allocated to a data channel, where the guard band is positioned in frequency between a first frequency range of the first resource block set and a second frequency range of a second resource block set of the set of multiple resource block sets and receive, based on the control message, a data message using resource blocks in the first resource block set and resource blocks in the guard band, the resource blocks in the first resource block set and the resource blocks in the guard band corresponding to an interlace indicated in the control message and selected from a set of multiple interlaces.

Some examples of the method, first UEs, and non-transitory computer-readable medium described herein may further include operations, features, means, or instructions for determining, based on the control message indicating that at least the portion of the guard band may have been allocated to the data channel, that the guard band may be higher in frequency than a frequency within which the control message may be received.

Some examples of the method, first UEs, and non-transitory computer-readable medium described herein may further include operations, features, means, or instructions for determining that at least the portion of the first resource block set may have been allocated to the data channel based on the control message being transmitted using the first resource block set.

Some examples of the method, first UEs, and non-transitory computer-readable medium described herein may further include operations, features, means, or instructions for obtaining, from the control message, an interlace index corresponding to the interlace and a subchannel of the data channel and identifying one or more resource blocks in the first resource block set and one or more resource blocks in the guard band based on the interlace index, where the subchannel of the data channel includes the one or more identified resource blocks in the first resource block set.

In some examples of the method, first UEs, and non-transitory computer-readable medium described herein, the control message further indicates that at least a portion of a second guard band may have been allocated to the data channel and the second guard band may be positioned in frequency between the first resource block set and a third resource block set of the set of multiple resource block sets, the first resource block set positioned in frequency between the second resource block set and the third resource block set.

Some examples of the method, first UEs, and non-transitory computer-readable medium described herein may further include operations, features, means, or instructions for obtaining, from the control message, an interlace index corresponding to the interlace and a subchannel of the data channel and identifying one or more resource blocks in the first resource block set, one or more resource blocks in the guard band, and one or more resource blocks in the second resource block set based on the interlace index, where the one or more resource blocks includes the one or more identified resource blocks in the first resource block set corresponding to the subchannel, the one or more identified resource blocks in the guard band, and the one or more identified resource blocks in the second guard band.

Some examples of the method, first UEs, and non-transitory computer-readable medium described herein may further include operations, features, means, or instructions for receiving the data message includes receiving the data message using one or more resource blocks in the first resource block set, one or more resource blocks in the guard band, and one or more resource blocks in the second guard band.

Some examples of the method, first UEs, and non-transitory computer-readable medium described herein may further include operations, features, means, or instructions for decoding the data message based on receiving the data message, where the second guard band may be lower in frequency than the first resource block set, and where decoding the data message includes decoding first data symbols of the data message obtained from the one or more resource blocks in the second guard band prior to decoding second data symbols obtained from the one or more resource blocks in the first resource block set, and decoding the second data symbols prior to decoding third data symbols obtained from the one or more resource blocks in the second guard band.

Some examples of the method, first UEs, and non-transitory computer-readable medium described herein may further include operations, features, means, or instructions for decoding the data message based on receiving the data message, where the second guard band may be lower in frequency than the first resource block set, and where decoding the data message includes decoding first data symbols of the data message obtained from the one or more resource blocks in the first resource block set prior to decoding second data symbols obtained from the one or more resource blocks in the guard band, and decoding the second data symbols prior to decoding third data symbols obtained from the one or more resource blocks in the second guard band.

In some examples of the method, first UEs, and non-transitory computer-readable medium described herein, at least a portion of the second resource block set may be allocated to a second data channel.

In some examples of the method, first UEs, and non-transitory computer-readable medium described herein, one or more pairs of proximal resource block sets within the set of multiple resource block sets may be separated in frequency from one another by respective guard bands.

### BRIEF DESCRIPTION OF THE DRAWINGS

FIG. 1 shows an example of a wireless communications system that supports guard band utilization for sidelink communications in accordance with one or more aspects of the present disclosure.

FIG. 2 shows an example of a resource diagram that supports guard band utilization for sidelink communications in accordance with one or more aspects of the present disclosure.

FIG. 3 shows an example of a resource diagram that supports guard band utilization for sidelink communications in accordance with one or more aspects of the present disclosure.

FIG. 4 shows an example of a resource diagram that supports guard band utilization for sidelink communications in accordance with one or more aspects of the present disclosure.

FIG. 5 shows an example of a resource diagram that supports guard band utilization for sidelink communications in accordance with one or more aspects of the present disclosure.

FIG. 6 shows an example of a set of operations that supports guard band utilization for sidelink communications in accordance with one or more aspects of the present disclosure.

FIGS. 7 and 8 show block diagrams of devices that support guard band utilization for sidelink communications in accordance with one or more aspects of the present disclosure.

FIG. 9 shows a block diagram of a communications manager that supports guard band utilization for sidelink communications in accordance with one or more aspects of the present disclosure.

FIG. 10 shows a diagram of a system including a device that supports guard band utilization for sidelink communications in accordance with one or more aspects of the present disclosure.

FIGS. 11 and 12 show block diagrams of devices that support guard band utilization for sidelink communications in accordance with one or more aspects of the present disclosure.

FIG. 13 shows a block diagram of a communications manager that supports guard band utilization for sidelink communications in accordance with one or more aspects of the present disclosure.

FIG. 14 shows a diagram of a system including a device that supports guard band utilization for sidelink communications in accordance with one or more aspects of the present disclosure.

FIGS. 15 and 16 show flowcharts illustrating methods that support guard band utilization for sidelink communications in accordance with one or more aspects of the present disclosure.

### DETAILED DESCRIPTION

A wireless communications system may support sidelink (SL) communications using an unlicensed band (which may be referred to as SL-U communications). The SL-U communication resources may include resource block sets, where the resource block sets may be separated from one another by intervening guard bands, and where resource blocks within the resource block sets may be assigned to interlaced subchannels. In some examples, multiple sidelink data channels (which may be referred to as PSSCHs) may be scheduled for successive resource block sets—e.g., a first sidelink data channel may be scheduled for a first resource block set, a second sidelink data channel may be scheduled for a second, successive resource block set, and so on. In such cases, resource blocks within the intervening intra-cell guard bands may be left unused.

But leaving the intervening intra-cell guard bands unused when multiple sidelink data channels are scheduled across multiple resource block sets may waste communication resources, which may reduce a spectral efficiency of SL-U resources. Thus, techniques and configurations that enable intra-cell guard band resources to be used when multiple sidelink data channels are scheduled across multiple resource block sets may be desired.

To use intra-cell guard band resource when multiple sidelink data channels are scheduled across multiple resource block sets, an indicator of whether resources in an intra-cell guard band next to a resource block set have been allocated to a sidelink data channel may be included in a control message that schedules the sidelink data channel for the resource block set.

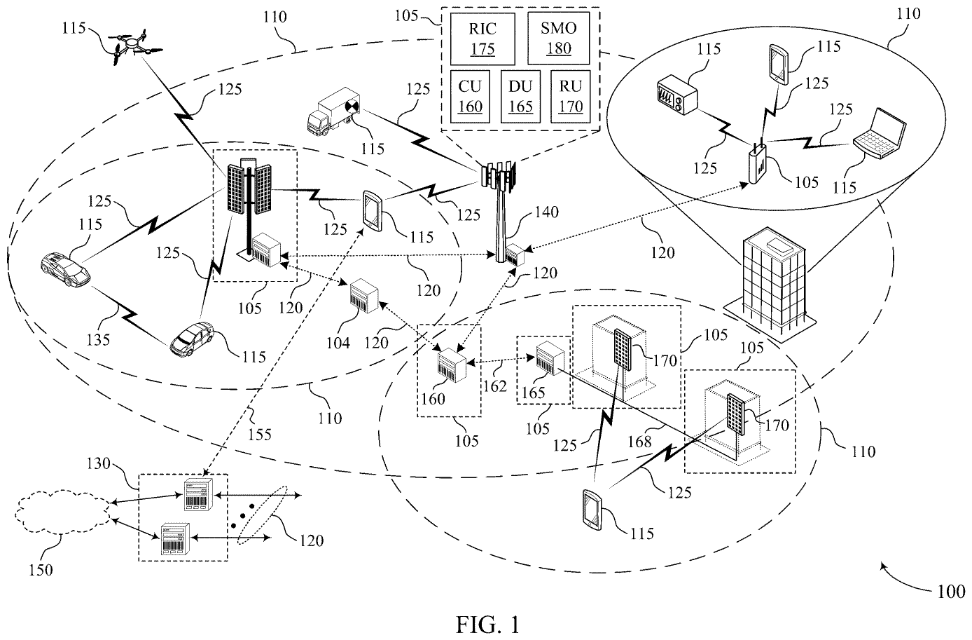

FIG. 1 shows an example of a wireless communications system 100 that supports guard band utilization for sidelink communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support guard band utilization for sidelink communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A wireless communications system 100 may support sidelink communications in unlicensed spectrum (which may be referred to as the sidelink unlicensed (SL-U) spectrum). In some examples, transmissions are performed in the SL-U spectrum as resource block-based transmissions that are interlaced in the frequency domain. For example, sidelink communications may be performed in one or more portions of the SL-U spectrum such that a set of interlace indices is assigned to a set of successive (in frequency) resource blocks in a respective portion of the SL-U spectrum (where the set of successive resource blocks and/or the portion of the SL-U spectrum may be referred to as a “resource block set”). For example, within a resource block set of the SL-U spectrum, a first interlace index (which may be referred to as a first interlace) may be assigned to a first resource block, a second interlace index (which may be referred to as a second interlace) may be assigned to a second resource block that is next (in frequency) to the first resource block, and so on, until all of the interlace indices are assigned to a resource block. If unassigned resource blocks remain in the resource block set after all of interlace indices are assigned, the pattern may repeat. That is, the first interlace index may be assigned to the first unassigned resource block next (in frequency) to the last assigned resource block, the second interlace index may be assigned to the next unassigned resource block next (in frequency) to the first unassigned resource block, and so on. This process may repeat until all of the resource blocks in the resource block set have been assigned an interlace index.

In some examples, resource block sets of the SL-U spectrum are separated from one another by intra-cell guard bands—e.g., an intra-cell guard band may be positioned between each successive resource block set—e.g., {resource block set 0 (RBS0), guard band 0 (GB0), RBS1, GB1, RBS2 . . . }. The intra-cell guard bands may mitigate interference between communications performed using successive resource block sets.

As the SL-U spectrum is in the unlicensed domain, a device may perform a procedure (which may be referred to as a “contention procedure”) for gaining access to the SL-U spectrum prior to transmitting data. In some examples, based on a successful contention procedure, a device may gain access to the SL-U spectrum (e.g., at least a portion of the SL-U spectrum), where the SL-U spectrum accessed by the device may include one or more resource block sets (e.g., one or more successive resource block sets). Based on gaining access to the SL-U spectrum, the device may reserve (e.g., schedule) the SL-U spectrum resources for data communications.

For example, the device may identify resource blocks within a resource block set of the SL-U spectrum and may assign interlace indices to the resource blocks, as described herein. Based on configuring the SL-U spectrum resources, the device may schedule a single PSSCH that spans a single resource block set. The device may further schedule one or more data transmissions for one or more other devices during the PSSCH. For example, as part of scheduling a data transmission for another device, the device may allocate, to a data message for the other device, data resources in resource blocks of the resource block set that correspond to a interlace index (which may correspond to a PSSCH subchannel). In such cases, to schedule the data transmission, the device may further transmit a control message (which may include sidelink control information, SLC-1) in the resource block set (e.g., in a PSCCH), where the control message may indicate an interlace (e.g., corresponding to interlace index_0) used for the data message for the other device (where the interlace may correspond to a PSCCH subchannel allocated to the data message). The device may also transmit the data message using the interlace (e.g., the resource blocks of the resource block set assigned the interlace index of the interlace) indicated in the control message.

Based on receiving the control message, the other device may identify the interlace (and PSCCH subchannel) used for the data message and may obtain the data message by decoding the signals (e.g., symbols) transmitted using the resource blocks of the resource block set that correspond to the interlace indicated in the control message.

In another example, the device may identify resource blocks within multiple, successive resource block sets of the SL-U spectrum as well as intra-cell guard bands positioned between the multiple, successive resource block sets. The device may assign interlace indices to the resource blocks within the successive resource block sets and to the resource blocks within the intra-cell guard bands, as described herein. Based on configuring the SL-U spectrum resources, the device may schedule a single PSSCH that spans multiple resource block sets. In such cases, the resource blocks within the intervening intra-cell guard bands may also be allocated to the PSSCH—e.g., because the other device may be capable of determining that a single device contended for and obtained access to the successive resource block sets based on the PSSCH allocation; in such cases, the device may be able to manage interference between communications in successive resource block sets.

The device may further schedule one or more data transmissions for one or more other devices in the PSSCH. For example, as part of scheduling a data transmission for another device, the device may allocate, to a data message for the other device, data resources in resource blocks of the multiple resource block sets and the intra-cell guard bands that correspond to an interlace. In such cases, to schedule the data transmission the device may further transmit a control message in one of the resource block sets that indicates the interlace used for the data message for the other device. The device may also transmit the data message using the resource blocks of the multiple resource block sets and the intra-cell guard bands that correspond to the interlace indicated in the control message.

Based on receiving the control message, the other device may identify the interlace (e.g., and a subchannel corresponding to the interlace) used for the data message and may obtain the data message by decoding the signals (e.g., symbols) transmitted using the resource blocks of the multiple resource block sets and intra-cell guard bands that correspond to the interlace indicated in the control message.

In yet another example, the device may identify resource blocks within multiple, successive resource block sets of the SL-U spectrum as well as intra-cell guard bands positioned between the multiple, successive resource block sets. The device may assign interlace indices to the resource blocks within the successive resource block sets, as described herein. Also, interlace indices may be assigned to the resource blocks within the intra-cell guard bands, where the interlace indices may correspond to respective interlace indices of the resource blocks. Based on configuring the SL-U spectrum resources, the device may schedule multiple sidelink data channels for the multiple resource block sets (e.g., a PSSCH for each of the multiple resource block sets). In such cases, the resource blocks within the intervening intra-cell guard bands may be left unused—e.g., because the other device may be unable to determine whether a single device contended for and obtained access to the successive resource block sets based on the sidelink data channel allocation (e.g., as the PSSCH allocation may be for a single resource block set).

But leaving the intervening intra-cell guard bands unused when multiple sidelink data channels are scheduled across multiple resource block sets may waste communication resources, which may reduce a spectral efficiency of SL-U resources. Thus, techniques and configurations that enable intra-cell guard band resources to be used when multiple sidelink data channels are scheduled across multiple resource block sets may be desired.

To use intra-cell guard band resource when multiple sidelink data channels are scheduled across multiple resource block sets, an indicator of whether resources in an intra-cell guard band next to a resource block set have been allocated to a sidelink data channel may be included in a control message that schedules the sidelink data channel for the resource block set.

In some examples, one or more devices (e.g., one or more UEs, one or more network entities, or a combination thereof) may contend for access to an unlicensed sidelink band that includes multiple resource block sets, where successive (in frequency) resource block sets of the multiple resource block sets may be separated from one another by respective guard bands. Based on the contending, the one or more devices may obtain access to at least a portion of the unlicensed sidelink. The portion of the unlicensed sidelink band may include one or more resource block sets (e.g., multiple successive resource block sets). Based on obtaining access to the portion of the unlicensed sidelink band, a first data channel (e.g., a first PSSCH) for a first other device may be scheduled for a first resource block set of the one or more resource block sets. In some examples, a second data channel (e.g., a second PSSCH) for the first other device or a second other device may be scheduled for a second, successive resource block set of the one or more resource block sets.

Based on the one or more data channels being scheduled for the one or more resource block sets, resource blocks (e.g., all of the resource blocks, a portion of the resource blocks, all of the resource blocks not allocated to a PSCCH) in the first resource block set may be allocated to the first data channel. Also, resource blocks (e.g., all or a portion of the resource blocks) in a first guard band that is next (in frequency) to the first resource block set may be allocated to the first data channel. In some examples, resource blocks in the first guard band are allocated to the first data channel based on a single device obtaining access to both the first resource block set and the second resource block set. In other examples, resource blocks in the first guard band are allocated to the first data channel based on a first device obtaining access to both the first resource block set and a second device (that cooperates with the device) gaining access to the second resource block set.

Based on resource blocks in the first guard band being allocated to the first data channel for the first other device, a first control message used to schedule the first data channel may include an indication (which may be referred to as a “guard band usage indication”) that the resource blocks in the first guard band have been allocated to the first data channel. In some examples, the indication may indicate whether the first guard band including the allocated resource blocks is located below (in frequency) the first resource block, above (in frequency) the first resource block, or both. In some examples, the first control message may be transmitted within the first resource block set. In some examples, the first control message may also include an indication of a interlace allocated to a data message (e.g., where the interlace index may correspond to a subchannel) for the other device and, in some examples, a quantity of interlaces (which may correspond to subchannels) allocated to a resource block set.

Based on the first control message, the first other device may determine that resource blocks in the first resource block set have been allocated to the data channel—e.g., based on receiving the first control message in the first resource block set. The first other device may also determine that (in addition to resource blocks in the first resource block set) resource blocks in the first guard band have been allocated to the data channel—e.g., based on the guard band usage indication. The first other device may identify first resource blocks in the first resource block and first resource blocks in the first guard band based on the interlace index indication. The first resource blocks in the first resource block set and the first resource blocks in the first guard band may be assigned to the data channel.

In some examples, based on the one or more data channels being scheduled for the one or more resource block sets, resource blocks in the second resource block set may similarly be allocated to the second data channel. Also, resource blocks in the first guard band and/or a second guard that is next (in frequency) to the second resource block set may similarly be allocated to the second data channel. In such cases, the first other device (or another device) may similarly identify second resource blocks in the second resource block set and second resource blocks in the first and/or second guard bands based on a location of a second control message used to schedule the second data channel, a guard band usage indication, and an interlace indication.

By including, in a control message (e.g., a PSCCH message) used to schedule a data message (e.g., PSSCH message) in a resource block set, an indication of whether a guard band next (in frequency) to the resource block set, guard band resources may be utilized when different data channels (e.g., different PSSCH channels) are scheduled in successive resource block sets, which may increase a spectral efficiency of SL-U resources.

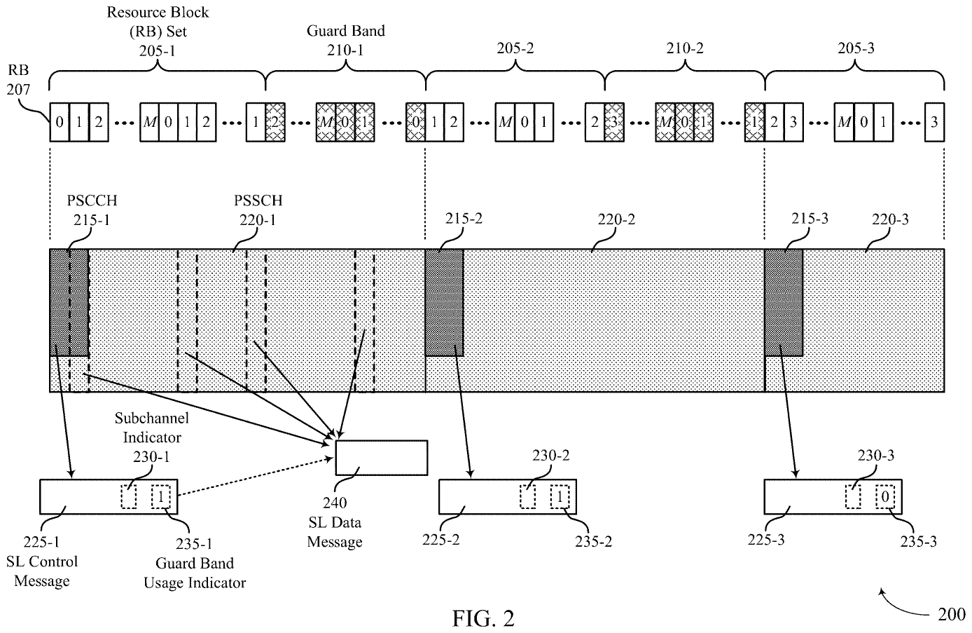

FIG. 2 shows an example of a resource diagram that supports guard band utilization for sidelink communications in accordance with one or more aspects of the present disclosure.

The resource diagram 200 depicts SL-U spectrum that supports resource block-based communication. The resource diagram 200 may include the resource block sets 205 and the guard bands 210, where the guard bands 210 may separate in frequency proximal resource block sets (e.g., neighboring resource block sets, resource block sets with no other resource block sets in between, such as resource block sets that would be adjacent but for the guard bands 210 in between) from one another. For example, the first guard band 210-1 may separate in frequency the first resource block set 205-1 from the second resource block set 205-2. The resource block sets 205 and the guard bands 210 may be partitioned into resource blocks (such as the resource block 207).

As described herein, in some examples, the resource blocks in the resource block sets 205 and the resource blocks in the guard bands 210 may be assigned interlace indices in accordance with a repeating interlace pattern. In some examples, a resource block assigned an interlace index may be referred to as an interlace. For example, the resource blocks (including resource block 207) assigned interlace index_0 may be referred to as interlace 0. In some examples, interlace indices may be assigned to the resource blocks, where a PSSCH subchannel may include the resource blocks that are assigned a corresponding index within a resource block set—e.g., a PSSCH subchannel_0 may include the resource blocks that are assigned interlace index_0 within a resource block set_0.

As described herein, a device (or a set of cooperative devices) may contend for and obtain access to a portion of the SL-U spectrum. For example, the portion of the SL-U spectrum may include the first resource block set 205-1, the first guard band 210-1, the second resource block set 205-2, the second guard band 210-2, and the third resource block set 205-3. As also described herein, the device(s) may schedule multiple PSSCHs for the resource block sets 205—e.g., a different PSSCH for each of the resource block sets 205. For example, the device(s) may schedule the first PSSCH 220-1 for the first resource block set 205-1, the second PSSCH 220-2 for the second resource block set 205-2, and the third PSSCH 220-3 for the third resource block set 205-3.

Based on scheduling the different PSSCHs for the resource block sets 205, the device(s) may allocate resource blocks in the guard band to one or more of the PSSCHs. For example, the device(s) may allocate resource blocks in the first guard band 210-1 to first PSSCH 220-1 and resource blocks in the second guard band 210-2 to second PSSCH 220-2.

Based on allocating resource blocks in the guard band to the one or more PSSCHs, the device(s) may map data symbols of a data message intended for another device to resources in a resource block set and to resources in a guard band. In some examples, the device(s) map the data symbols of the data message to resources in the resource block set that correspond to a particular interlace index (and subchannel) and resources in the guard band assigned the interlace index. For example, a device may map the SL data message 240 (which may be intended for another device) to a first interlace (and subchannel) of the first PSSCH 220-1 (e.g., interlace_1 and subchannel_1) in the first resource block set 205-1 and to resource blocks assigned the corresponding interlace index (e.g., interlace_1) in the first guard band 210-1.

To alert the other device to the existence and location of the SL data message 240, the device may also map the first SL control message 225-1 to resources in the first PSCCH 215-1. In some examples, the first SL control message 225-1 is generated in accordance with a sidelink control information format (e.g., SCI-1). In some examples, the first SL control message 225-1, by its existence within the first resource block set 205-1, indicates that the first PSSCH 220-1 is scheduled for the first resource block set 205-1. Also, the first SL control message 225-1 may include the first interlace index indicator 230-1 and the first guard band usage indicator 235-1. The first interlace index indicator 230-1 may indicate which interlace index (and subchannel) of the first PSSCH 220-1 is assigned to the SL data message 240. The first guard band usage indicator 235-1 may indicate whether an adjacent guard band that is higher in frequency than the first resource block set 205-1 (here, the first guard band 210-1) is allocated to the first PSSCH 220-1. The first guard band usage indicator 235-1 may be a single-bit indicator, where a first bit value (e.g., 0) may indicate that the adjacent, higher guard band has not been assigned to the first PSSCH 220-1 and a second bit value (e.g., 1) may indicate that the adjacent, higher guard band has been allocated to the first PSSCH 220-1.

Although, in the example of FIG. 2, the guard band usage indicators indicate whether an adjacent, higher guard band is allocated to a corresponding PSSCH scheduled for a resource block set, in some examples, the guard band usage indicators may instead be configured to indicate whether an adjacent, lower guard band is allocated to the corresponding PSSCH. That is, the guard band usage indicators may together be configured to indicate one of whether an adjacent, higher guard band or an adjacent, lower guard band is allocated to a corresponding PSSCH. By configuring the guard band usage indicators to indicate whether an adjacent, higher guard band is allocated to a corresponding PSSCH, an alignment (in frequency) of the PSCCH and the PSSCH may be maintained.

Another device may receive the first SL control message 225-1. Based on receiving the first SL control message 225-1, the other device may identify communications resources used to convey the SL data message 240. For example, the other device may determine that resources of the first PSSCH 220-1 are scheduled for the SL data message 240 within the first resource block set 205-1 based on receiving the first SL control message 225-1 using resources of the first PSCCH 215-1 within the first resource block set 205-1. The other device may also determine that resources of the first PSSCH 220-1 are scheduled for the SL data message 240 within the first guard band 210-1 based on the first guard band usage indicator 235-1 indicating that the first guard band 210-1 has been allocated to the first PSSCH 220-1. The other device may further determine that the resources of the first PSSCH 220-1 that are scheduled for the SL data message 240 are located within a subchannel of the first PSSCH 220-1 (e.g., subchannel_1) based on the first interlace index indicator 230-1 indicating a first interlace index (e.g., interlace index_1). Accordingly, the other device may determine that the resources of the first PSSCH 220-1 that are scheduled for the SL data message 240 include the resource blocks of the first resource block set 205-1 and the resource blocks of the first guard band 210-1 having the interlace index that corresponds to the indicated subchannel—e.g., as depicted in FIG. 2 by the arrows extending from the strips of the PSSCH subchannel.

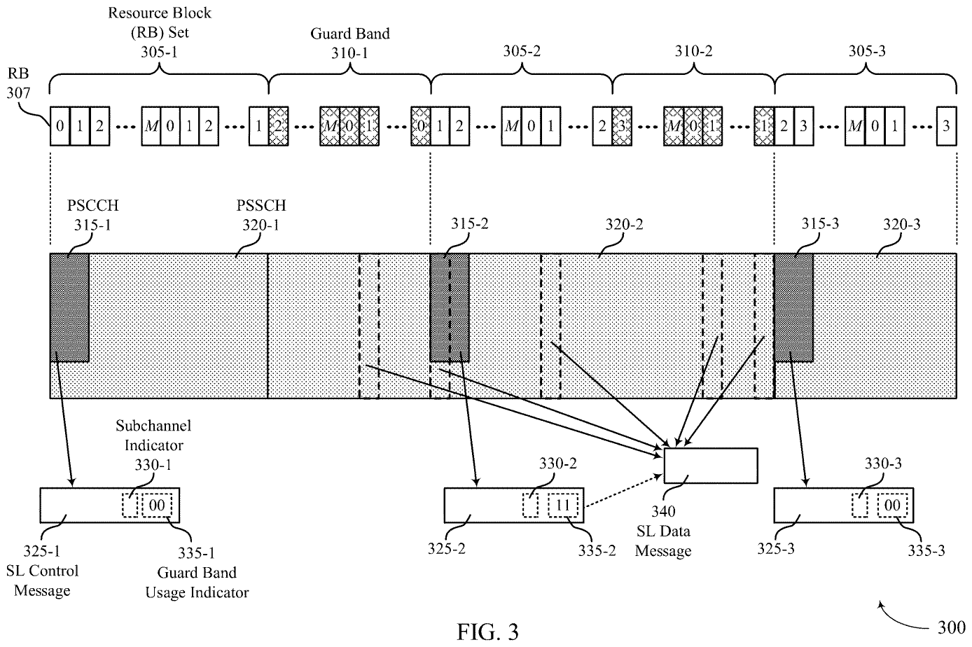

FIG. 3 shows an example of a resource diagram that supports guard band utilization for sidelink communications in accordance with one or more aspects of the present disclosure.

The resource diagram 300 depicts SL-U spectrum that supports resource block-based communication, where the SL-U spectrum may be an example of or the same as the SL-U spectrum described herein, including with reference to FIG. 2. As described with reference to FIG. 2, device(s) may contend for and obtain access to a portion of the SL-U spectrum and may schedule different PSSCHs for the resource block sets 305. And based on scheduling the different PSSCHs, the device(s) may allocate resource blocks in the guard band to one or more of the PSSCHs.

In contrast to FIG. 2, the device(s) may allocate, to a PSSCH, resource blocks in a guard band that is lower (in frequency) than a resource block set in which the PSSCH is scheduled, resource blocks in a guard band that is higher (in frequency) than a resource block set in which the PSSCH is scheduled, or both. To support allocating resource blocks in a lower guard band, an upper guard band, or both, to a PSSCH, SL control messages may include guard band usage indicators that have multiple bits. A first bit of a guard band usage indicator may indicate whether a lower guard band is allocated to a PSSCH scheduled for a resource block set, and a second bit of the guard band usage indicator may indicate whether a higher guard band is allocated to the PSSCH.

For example, the device(s) may allocate resource blocks (like the resource block 307) in the first guard band 310-1 and resource blocks the second guard band 310-2 to the second PSSCH 320-2. In some examples, a portion (or all) of the resource blocks in the first guard band 310-1 may be allocated to the second PSSCH 320-2, and a portion (or all) of the resource blocks in the second guard band 310-2 may be allocated to the second PSSCH 320-2. Based on allocating the resource blocks to the second PSSCH 320-2, data symbols for a data message intended for another device may be mapped to resource blocks in the first guard band 310-1, to resource blocks in the second resource block set 305-2, and to resource blocks in the second guard band 310-2.

To alert the other device to the existence and location of the SL data message 340, the device may also map the second SL control message 325-2 to resources in the second PSCCH 315-2. In some examples, the second SL control message 325-2 is generated in accordance with a sidelink control information format (e.g., SCI-1). In some examples, the second SL control message 325-2, by its existence within the second resource block set 305-2, indicates that the second PSSCH 320-2 is scheduled for the second resource block set 305-2. Also, the second SL control message 325-2 may include the second interlace index indicator 330-2 and the second guard band usage indicator 335-2. The second interlace index indicator 330-2 may indicate which interlace (and subchannel) of the second PSSCH 320-2 is assigned to the SL data message 340. The second guard band usage indicator 335-2 may indicate whether an adjacent guard band that is lower in frequency than the second resource block set 305-2 (here, the first guard band 310-1) is allocated to the second PSSCH 320-2. The second guard band usage indicator 335-2 may also indicate whether an adjacent guard band that is higher in frequency than the second resource block set 305-2 (here, the second guard band 310-2) is allocated to the second PSSCH 320-2.

The second guard band usage indicator 335-2 may be a two-bit indicator, where a first bit value (e.g., 0) of the first bit may indicate that the adjacent, lower guard band has not been assigned to the second PSSCH 320-2, and a second bit value (e.g., 1) of the first bit may indicate that the adjacent, lower guard band has been allocated to the second PSSCH 320-2. Also, a first bit value (e.g., 0) of the second bit may indicate that the adjacent, higher guard band has not been assigned to the second PSSCH 320-2, and a second bit value (e.g., 1) of the second bit may indicate that the adjacent, higher guard band has been allocated to the second PSSCH 320-2.

In some examples, a single guard band (e.g., the first guard band 310-1) may be assigned to multiple PSSCHs (e.g., to the first PSSCH 320-1 and to the second PSSCH 320-2). In some examples, whether a single guard band may be assigned to multiple PSSCHs may be based on a quantity of interlace indices assigned to a resource block set. For example, a single guard band may be assigned to multiple PSSCHs if a first set of interlace indices (e.g., corresponding to a first set of subchannels) are able to be assigned to a first PSSCH and a second set of interlace indices (e.g., corresponding to a second set of subchannels) are able to be assigned to a second PSSCH such that at least one unused subchannel is positioned between the first set of interlace indices and the second set of interlace indices and, in some examples, such that at least one unused interlace index separates the second PSSCH from the first PSSCH at the ends of the guard band. For example, a single guard band may be assigned to multiple PSSCHs when there are six interlace indices, interlace index_0 to interlace index_5 (or subchannels, subchannel_0 through subchannel_5), if interlace index_0 (which may correspond to subchannel_0) is assigned to a first PSSCH (e.g., the first PSSCH 320-1) and interlace index_3 (which may correspond to subchannel_3) is assigned to a second PSSCH (e.g., the second PSSCH 320-2). In such cases, resource blocks having interlace indices_1, 2, 4, and 5 (corresponding to subchannels_1, 2, 4, and 5) may be unused within the guard band—e.g., to mitigate interference between the transmissions using the two PSSCHs.

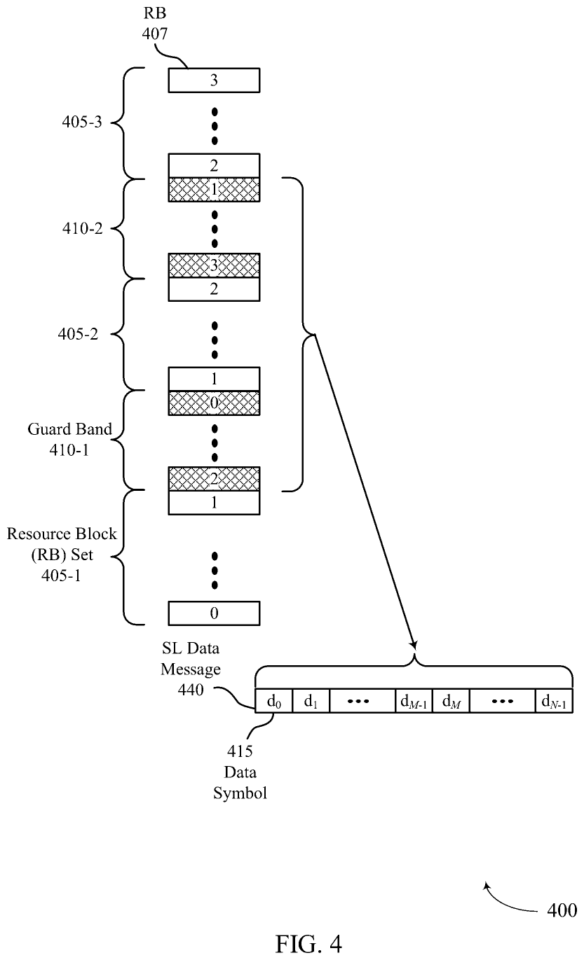

FIG. 4 shows an example of a resource diagram that supports guard band utilization for sidelink communications in accordance with one or more aspects of the present disclosure.

The resource diagram 400 depicts a mapping of data symbols (e.g., including the data symbol 415) of an SL data message (e.g., the SL data message 440) to SL-U spectrum when a data message includes resource blocks (like the resource block 407) in a resource block set (e.g., the second resource block set 405-2) and resource blocks in a guard band (e.g., the first guard band 410-1) that is lower in frequency than the resource block set, where the resource blocks in the resource block set and the guard band may share an interlace. In some examples, the SL data message 440 is an example of an SL data message described herein—e.g., the SL data message 340 of FIG. 3.

As depicted in FIG. 4, the data symbols of the SL data message 440 may be arranged in an order that corresponds to the frequency order of the resource blocks assigned to the interlace. That is, the first (in order) data symbols of the SL data message 440 may correspond to the data symbols obtained from the resource blocks in the first guard band 410-1 that are assigned to the interlace (e.g., the resource blocks in the first guard band 410-1 assigned an interlace index). The second (in order) data symbols of the SL data message 440 may correspond to the data symbols obtained from the resource blocks in the second resource block set 405-2 that are assigned to the interlace (e.g., the resource blocks in the second resource block set 405-2 assigned to the interlace index, which may correspond to a PSSCH subchannel). And the third (in order) data symbols of the SL data message 440 may correspond to the data symbols obtained from the resource blocks in the second guard band 410-2 that are assigned to the interlace (e.g., the resource blocks in the second guard band 410-2 assigned the interlace index).

Another device may decode the SL data message 440 in accordance with the ordering depicted in FIG. 4. That is, the other device may decode the data symbols obtained from the first guard band 410-1 before (in time) the data symbols obtained from the second resource block set 405-2. And the other device may decode the data symbols obtained from the second resource block set 405-2 before (in time) the data symbols obtained from the second guard band 410-2.

In some examples, there may be no resources assigned to the SL data message 440 in the second guard band 410-2 (which may be higher in frequency than the second resource block set 405-2). In such examples, the data symbols corresponding to the second guard band 410-2 may not be included in the SL data message 440. In such cases, the data symbols of the SL data message 440 may begin with the data symbols obtained from the first guard band 410-1 and end with the data symbols obtained from the second resource block set 405-2.

In some examples, there may be no resources assigned to the SL data message440 in the first guard band 410-1 (which may be lower in frequency than the second resource block set 405-2). In such examples, the data symbols corresponding to the first guard band 410-1 may not be included in the SL data message 440. In such cases, the data symbols of the SL data message 440 may begin with the data symbols obtained from the second resource block set 405-2 and end with the data symbols obtained from the second guard band 410-2.

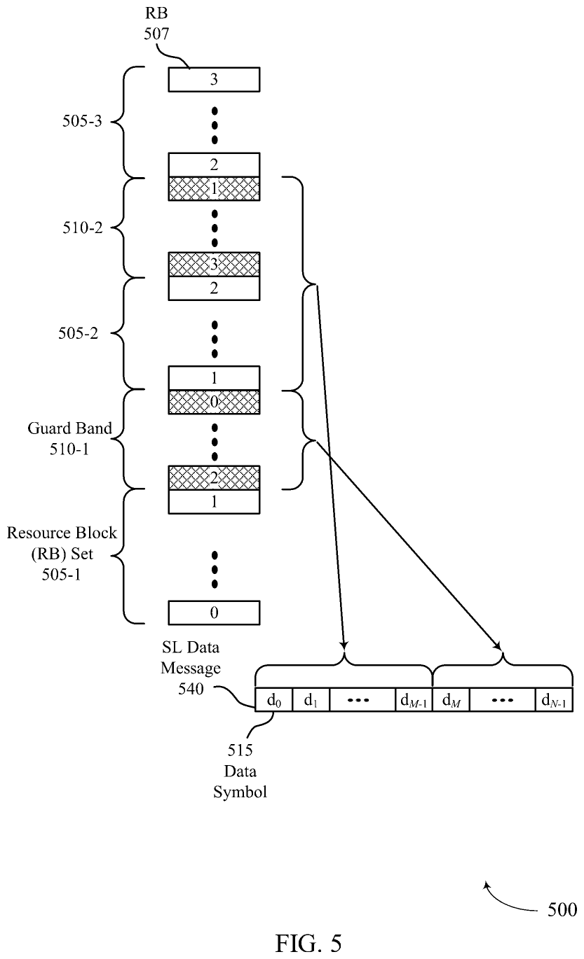

FIG. 5 shows an example of a resource diagram that supports guard band utilization for sidelink communications in accordance with one or more aspects of the present disclosure.

The resource diagram 500 depicts a mapping of data symbols (e.g., including the data symbol 515) of an SL data message (e.g., the SL data message 540) to SL-U spectrum when a data message includes resource blocks (e.g., like the resource block 507) in a resource block set (e.g., the second resource block set 505-2) and resource blocks in a guard band (e.g., the first guard band 510-1) that is lower in frequency than the resource block set, where the resource blocks in the resource block set and the guard band may share an interlace. In some examples, the SL data message 540 is an example of an SL data message described herein—e.g., the SL data message 340 of FIG. 3.

As depicted in FIG. 5, the data symbols of the SL data message 540 may be arranged in an order that is different than the frequency order of the resource blocks assigned to the interlace. That is, the first (in order) data symbols of the SL data message 540 may correspond to the data symbols obtained from the resource blocks in the second resource block set 505-2 that are assigned to the interlace (which may correspond to the resource blocks in the second resource block set 505-2 assigned an interlace index, which may correspond to a PSSCH subchannel). The second (in order) data symbols of the SL data message 540 may correspond to the data symbols obtained from the resource blocks in the second guard band 510-2 that are assigned to the interlace (e.g., the resource blocks in the second guard band 510-2 assigned to the interlace index). And the third (in order) data symbols of the SL data message 540 may correspond to the data symbols obtained from the resource blocks in the first guard band 510-1 that are assigned to the interlace (e.g., the resource blocks in the first guard band 510-1 assigned to the first interlace index).

Another device may decode the SL data message 540 in accordance with the ordering depicted in FIG. 5. That is, the other device may decode the data symbols obtained from the second resource block set 505-2 before (in time) the data symbols obtained from the second guard band 510-2. And the other device may decode the data symbols obtained from the second guard band 510-2 before (in time) the data symbols obtained from the first guard band 510-1.

In some examples, there may be no resources assigned to the SL data message 540 in the second guard band 510-2 (which may be higher in frequency than the second resource block set 505-2). In such examples, the data symbols corresponding to the second guard band 510-2 may not be included in the SL data message 540. In such cases, the data symbols of the SL data message 540 may begin with the data symbols obtained from the second resource block set 505-2 and end with the data symbols obtained from the first guard band 510-1.

In some examples, there may be no resources assigned to the SL data message 540 in the first guard band 510-1 (which may be lower in frequency than the second resource block set 505-2). In such examples, the data symbols corresponding to the first guard band 510-1 may not be included in the SL data message 540. In such cases, the data symbols of the SL data message 540 may begin with the data symbols obtained from the second resource block set 505-2 and end with the data symbols obtained from the second guard band 510-2.

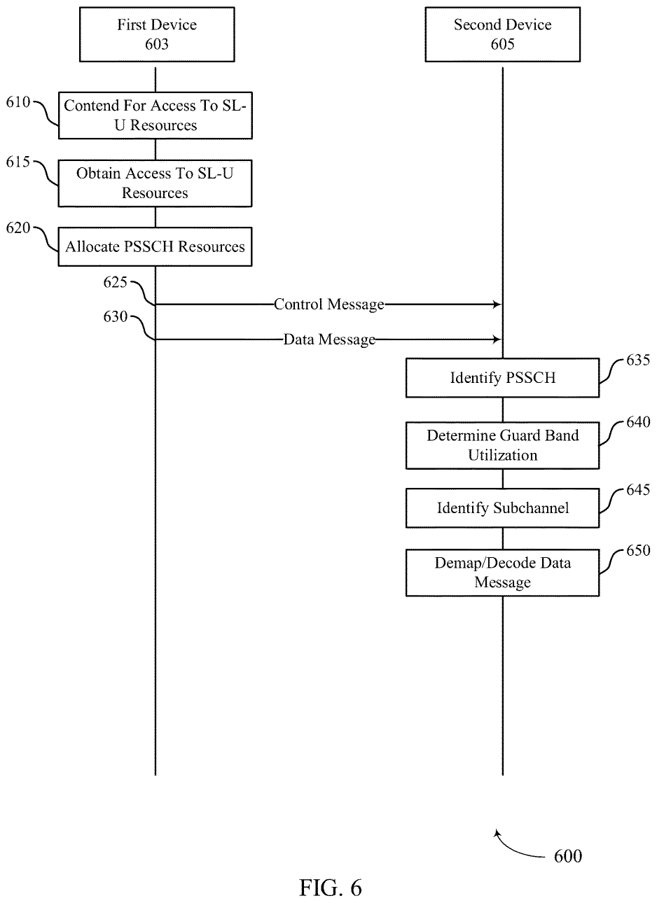

FIG. 6 shows an example of a set of operations that supports guard band utilization for sidelink communications in accordance with one or more aspects of the present disclosure.

The process flow 600 may be performed by the first device 603 and the second device 605, which may be each be examples of a UE or a network entity described herein. In some examples, the process flow 600 illustrates an example set of operations performed to support guard band utilization for sidelink communications. For example, the process flow 600 may include operations for utilizing and indicating a utilization of intra-cell guard bands when multiple resource block sets are assigned multiple sidelink data channels.

At 610, access to SL-U resources may be contended for (e.g., by the first device 603). In some examples, the first device 603 may perform a contention procedure for gaining access to the SL-U resources.

At 615, access to the SL-U resources may be obtained. In some examples, the first device 603 may gain access to a portion or all of the SL-U resources based on the contention procedure. The portion of the SL-U resources (which may include all of the SL-U resources) may include one or more resource block sets that are separated by one or more guard bands. In some examples, the portion of the SL-U resources includes one resource block set. In other examples, the portion of the SL-U resources includes multiple resource block sets that are separated from one another by one or more guard bands.

At 620, resources in the portion of the SL-U resources may be allocated to one or more data channels (e.g., PSSCH). In some examples, the first device 603 may allocate available resource blocks in a resource block set within the portion of the SL-U resources to a data channel. The first device 603 may further allocate resource blocks in a guard band that is adjacent to the resource block set to the data channel. In some examples, the first device 603 indicates resources blocks in a guard band that is higher in frequency than the resource block set—e.g., to maintain alignment (in frequency, time, or both) of a beginning of the control channel and a beginning of a data channel.

In some examples, the first device 603 may allocate available resource blocks in a first resource block set within the portion of the SL-U resources to a first data channel and available resource blocks in a second resource block set within the portion of the SL-U resources to a second data channel. In some examples, the first resource block set and the second resource block set may be proximate to one another (e.g., may be successively or consecutively indexed). For example, the first resource block set may be designated as resource block set_0 and the second resource block set may be designated as resource block set_1. The first device 603 may further allocate resource blocks in a guard band that is positioned between the resource block sets to the data channel. In some examples, the first device 603 allocates the resource blocks in the guard band to the data channel as a result of obtaining access to the proximate resource block sets and scheduling different data channels in the proximate resource block sets. That is, in some examples, the first device 603 may not allocate resource blocks if the first device 603 obtains access to only a single resource block set or if the first device 603 obtains access to multiple resource block sets but schedules a single data channel for the multiple resource block sets.

At 625, a control message may be transmitted (e.g., from the first device 603) to the second device 605. The control message may be transmitted within a control channel (e.g., a PSCCH). The control message may include sidelink control information and, in some examples, may be configured in accordance with a sidelink control information format (e.g., SCI-1).

The control message may be configured to indicate a position of resources that are allocated to a data message within a data channel. In some examples, a resource block set is assigned to the data channel. In some examples, the control message may implicitly indicate that resource block set is assigned to the data channel by its being transmitted within the resource block set.

The control message may include a guard band usage indicator that indicates whether resources in one or more guard bands next to the resource block set are assigned to the data channel. In some examples, the guard band usage indicator is a single-bit indicator, as described herein including with reference to FIG. 3. In such cases, the guard usage indicator may indicate whether resources in the adjacent guard band that is higher in frequency than the resource block set is assigned to the data channel. Alternatively, the guard usage indicator may indicate whether resources in the adjacent guard band that is lower in frequency than the resource block set is assigned to the data channel. Configuring guard band usage indicators to indicate resources in a higher frequency guard band may maintain an alignment (in frequency, time, or both) of a beginning of respective control channels and a beginning of respective data channels.

In other examples, the guard band usage indicator is a two-bit indicator, as described herein including with reference to FIG. 4. In such cases, a first bit of the guard band usage indicator may indicate whether resources in the adjacent guard band that is lower in frequency than the resource block set is assigned to the data channel. And the second bit of the guard band usage indicator may indicate whether resources in the adjacent guard band that is higher in frequency than the resource block set is assigned to the data channel.

The control message may include an indicator (e.g., an interlace index indicator) that indicates a subchannel of the data channel that is assigned to the data message. In some examples, the indicator indicates an interlace index (which may correspond to an index of the subchannel assigned to the data message).

The first device 603 may transmit additional control messages (concurrently with the control message), where the control messages may schedule data messages in other data channels using resources of other resource block sets (e.g., that are proximate to the resource block sets).

At 630, a data message may be transmitted (e.g., from the first device 603) to the second device 605. The data message may be transmitted within a data channel (e.g., PSSCH) that corresponds to the control channel in which the control message is received.

At 635, a data channel associated with the control message may be identified (e.g., by the second device 605)—e.g., based on the control message. In some examples, the second device 605 may determine that the resource block set used to transmit the control message is also assigned to the data channel based on the control message being transmitted within the resource block set.

At 640, a utilization of one or more of the guard bands that are adjacent to the resource block set may be determined (e.g., by the second device 605)—e.g., based on the control message. In some examples, the utilization of the one or more guard bands may be determined based on a guard band usage indicator included in the control message, where the guard band usage indicator may indicate whether resources in the one or more guard bands are assigned to the data channel.

In some examples, the guard band usage indicator is a single-bit indicator. In such cases, the second device 605 may determine whether resources in the adjacent guard band that is higher in frequency is assigned to the data channel based on a value of the single-bit indicator. For example, if the value of the bit is equal to ‘0’, the second device 605 may determine that resources in the higher frequency guard band are not assigned to the data channel. Otherwise, if the value of the bit is equal to ‘1’, the second device 605 may determine that resources in the higher frequency guard band are assigned to the data channel. In an alternative option, the single-bit guard band usage indicators may similarly be used to indicate whether resources in lower frequency adjacent guard bands are assigned to the data channel.

In other examples, the guard band usage indicator is a multi-bit indicator. In such cases, the second device 605 may determine whether resources in the lower frequency adjacent guard band, the higher frequency adjacent guard band, or both, are assigned to the data channel based on a value of the multi-bit indicator. For example, if the value of the first bit of the multi-bit indicator is equal to ‘0’, the second device 605 may determine that resources in the lower frequency guard band are not assigned to the data channel. Otherwise, if the value of the first bit of the multi-bit indicator is equal to ‘1’, the second device 605 may determine that resources in the lower frequency guard band are assigned to the data channel. Also, if the value of the second bit of the multi-bit indicator is equal to ‘0’, the second device 605 may determine that resources in the higher frequency guard band are not assigned to the data channel. Otherwise, if the value of the second bit of the multi-bit indicator is equal to ‘1’, the second device 605 may determine that resources in the higher frequency guard band are assigned to the data channel.

At 645, an interlace (and corresponding subchannel) of the data channel (e.g., a PSSCH subchannel) that is used to convey the data message may be identified (e.g., by the second device 605)—e.g., based on the control message. In some examples, the interlace (and corresponding subchannel) may be identified based on an interlace index indicated in the control channel. In some examples, the second device 605 determines that a certain subchannel (e.g., subchannel_1) is used to convey the data message scheduled by the control message based on the received interlace index.

Based on identifying the resource block set assigned to the PSSCH, one or more guard bands assigned to the PSSCH, and the subchannel used to convey the data message, the second device 605 may identify resource blocks in the resource block set that correspond to the subchannel and resource blocks in the one or more guard bands that are assigned an interlace index corresponding to the subchannel, where the resource blocks in the resource block set and in the one or more guard bands may be allocated to the data message, as described herein including with reference to FIGS. 3 and 4.

At 650, the data message may be obtained (e.g., by the second device 605) from the resource blocks in the PSSCH and the resource blocks in the one or more guard bands that are allocated to the data message. To obtain the data message, the second device 605 may demap the data symbols received in the resource blocks (e.g., to demap the data symbols, the second device 605 may perform one or more operations to ascribe different symbols received in the resource blocks to the data message, which may correspond to an unmapping or reverse mapping process relative to the manner in which different data symbols of the data message were previously mapped to different resource blocks by the first device 603). Based on demapping the data symbols, the second device 605 may obtain a set of data bits and decode the data bits. The second device 605 may process the data symbols in accordance with a modulation and coding scheme to obtain the underlying data include in data message.

In some examples, the second device 605 may demap/decode the data symbols in accordance with a first pattern, as described herein including with reference to FIG. 4. For example, the second device 605 may demap/decode the data symbols transmitted in the lowest frequency resource blocks first and then decode the remaining data symbols in order of ascending frequency. That is, starting with the lowest frequency data symbol in the data channel (which may be in either the lower frequency guard band or the resource block set), the second device 605 may demap the data symbols in ascending order until the highest frequency data symbol (which may be in the higher frequency guard band) is demapped/decoded. The second device 605 may decode the resulting data bits in the same order as the demapping.

In other examples, the second device 605 may demap/decode the data symbols in accordance with a second pattern, as described herein including with reference to FIG. 5. For example, the second device 605 may demap/decode the data symbols transmitted in the lowest frequency resource block of the resource block set first, next decode the higher frequency data symbols in the resource block set and, in some examples, a higher frequency guard band, in order of ascending frequency, and then, in some examples, wrap around to decode the data symbols in the lower frequency guard in order of ascending frequency. That is, starting with the lowest frequency data symbol in the resource block set, the second device 605 may demap the data symbols in ascending order until the highest frequency data symbol (which may be in the higher frequency guard band) is demapped/decoded. After demapping the highest frequency data symbol, if a lower frequency guard band includes data symbols for the data message, the second device 605 may then wrap around to demap the data symbols in the lower frequency guard band. The second device 605 may decode the resulting data bits in the same order as the demapping.

Aspects of the process flow 600 may be implemented by a controller, among other components. Additionally, or alternatively, aspects of the process flow 600 may be implemented as instructions stored in memory (e.g., firmware stored in a memory coupled with a controller). For example, the instructions, when executed by a controller, may cause the controller to perform the operations of the process flow 600.

One or more of the operations described in the process flow 600 may be performed earlier or later, omitted, replaced, supplemented, or combined with another operation. Also, additional operations described herein may replace, supplement or be combined with one or more of the operations described in the process flow 600.

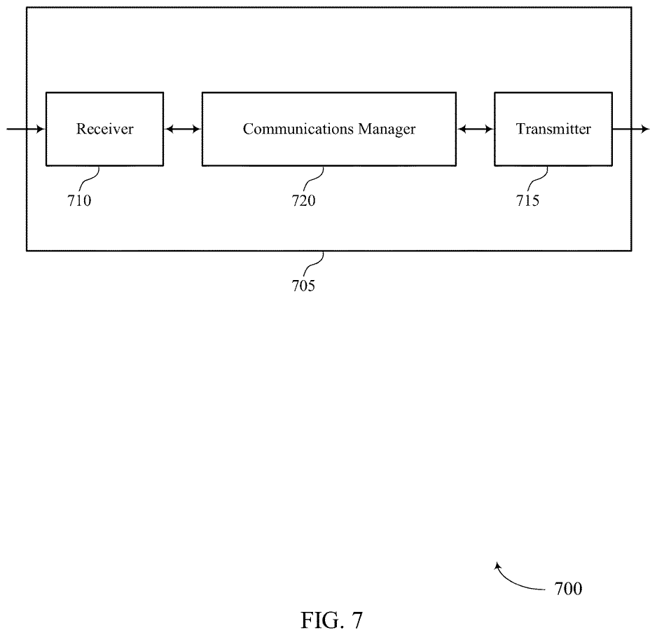

FIG. 7 shows a block diagram 700 of a device 705 that supports guard band utilization for sidelink communications in accordance with one or more aspects of the present disclosure. The device 705 may be an example of aspects of a UE 115 or a network entity 105 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to guard band utilization for sidelink communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to guard band utilization for sidelink communications). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of guard band utilization for sidelink communications as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor. If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving, using a first resource block set of a set of multiple resource block sets in an unlicensed sidelink band, a control message for the first UE, the control message indicating that at least a portion of the first resource block set and at least a portion of a guard band have been allocated to a data channel, where the guard band is positioned in frequency between a first frequency range of the first resource block set and a second frequency range of a second resource block set of the set of multiple resource block sets. The communications manager 720 is capable of, configured to, or operable to support a means for receiving, based on the control message, a data message using resource blocks in the first resource block set and resource blocks in the guard band, the resource blocks in the first resource block set and the resource blocks in the guard band corresponding to an interlace indicated in the control message and selected from a set of multiple interlaces.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for more efficiently using SL-U resource by utilizing guard band resources in obtained SL-U resources.

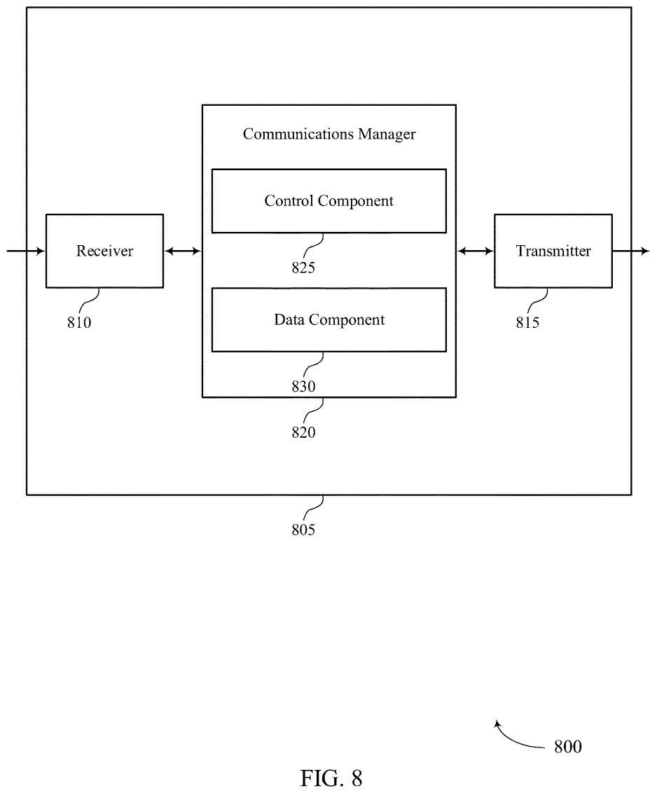

FIG. 8 shows a block diagram 800 of a device 805 that supports guard band utilization for sidelink communications in accordance with one or more aspects of the present disclosure. The device 805 may be an example of aspects of a device 705 or a UE 115 as described herein. The device 805 may include a receiver 810, a transmitter 815, and a communications manager 820. The device 805, or one of more components of the device 805 (e.g., the receiver 810, the transmitter 815, and the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to guard band utilization for sidelink communications). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to guard band utilization for sidelink communications). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of guard band utilization for sidelink communications as described herein. For example, the communications manager 820 may include a control component 825 a data component 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The control component 825 is capable of, configured to, or operable to support a means for receiving, using a first resource block set of a set of multiple resource block sets in an unlicensed sidelink band, a control message for the first UE, the control message indicating that at least a portion of the first resource block set and at least a portion of a guard band have been allocated to a data channel, where the guard band is positioned in frequency between a first frequency range of the first resource block set and a second frequency range of a second resource block set of the set of multiple resource block sets. The data component 830 is capable of, configured to, or operable to support a means for receiving, based on the control message, a data message using resource blocks in the first resource block set and resource blocks in the guard band, the resource blocks in the first resource block set and the resource blocks in the guard band corresponding to an interlace indicated in the control message and selected from a set of multiple interlaces.

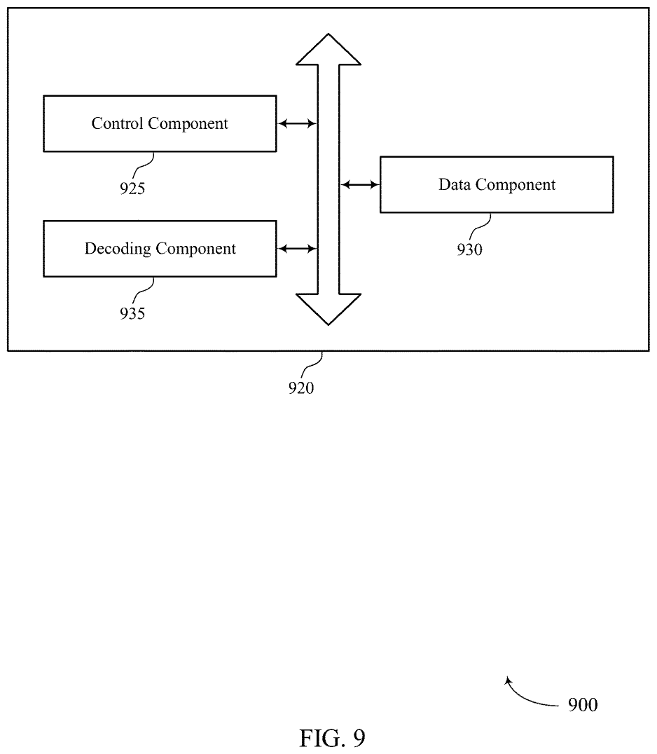

FIG. 9 shows a block diagram 900 of a communications manager 920 that supports guard band utilization for sidelink communications in accordance with one or more aspects of the present disclosure. The communications manager 920 may be an example of aspects of a communications manager 720, a communications manager 820, or both, as described herein. The communications manager 920, or various components thereof, may be an example of means for performing various aspects of guard band utilization for sidelink communications as described herein. For example, the communications manager 920 may include a control component 925, a data component 930, a decoding component 935, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The control component 925 is capable of, configured to, or operable to support a means for receiving, using a first resource block set of a set of multiple resource block sets in an unlicensed sidelink band, a control message for the first UE, the control message indicating that at least a portion of the first resource block set and at least a portion of a guard band have been allocated to a data channel, where the guard band is positioned in frequency between a first frequency range of the first resource block set and a second frequency range of a second resource block set of the set of multiple resource block sets. The data component 930 is capable of, configured to, or operable to support a means for receiving, based on the control message, a data message using resource blocks in the first resource block set and resource blocks in the guard band, the resource blocks in the first resource block set and the resource blocks in the guard band corresponding to an interlace indicated in the control message and selected from a set of multiple interlaces.

In some examples, the data component 930 is capable of, configured to, or operable to support a means for determining, based on the control message indicating that at least the portion of the guard band has been allocated to the data channel, that the guard band is higher in frequency than a frequency within which the control message is received.

In some examples, the data component 930 is capable of, configured to, or operable to support a means for determining that at least the portion of the first resource block set has been allocated to the data channel based on the control message being transmitted using the first resource block set.

In some examples, the control component 925 is capable of, configured to, or operable to support a means for obtaining, from the control message, an interlace index corresponding to the interlace and a subchannel of the data channel. In some examples, the data component 930 is capable of, configured to, or operable to support a means for identifying one or more resource blocks in the first resource block set and one or more resource blocks in the guard band based on the interlace index, where the subchannel of the data channel includes the one or more identified resource blocks in the first resource block set.

In some examples, the control message further indicates that at least a portion of a second guard band has been allocated to the data channel. In some examples, the second guard band is positioned in frequency between the first resource block set and a third resource block set of the set of multiple resource block sets, the first resource block set positioned in frequency between the second resource block set and the third resource block set.

In some examples, the control component 925 is capable of, configured to, or operable to support a means for obtaining, from the control message, an interlace index corresponding to the interlace and a subchannel of the data channel. In some examples, the data component 930 is capable of, configured to, or operable to support a means for identifying one or more resource blocks in the first resource block set, one or more resource blocks in the guard band, and one or more resource blocks in the second resource block set based on the interlace index, where the one or more resource blocks includes the one or more identified resource blocks in the first resource block set corresponding to the subchannel, the one or more identified resource blocks in the guard band, and the one or more identified resource blocks in the second guard band.

In some examples, receiving the data message includes receiving the data message using one or more resource blocks in the first resource block set, one or more resource blocks in the guard band, and one or more resource blocks in the second guard band.

In some examples, the decoding component 935 is capable of, configured to, or operable to support a means for decoding the data message based on receiving the data message, where the second guard band is lower in frequency than the first resource block set, and where decoding the data message includes decoding first data symbols of the data message obtained from the one or more resource blocks in the second guard band prior to decoding second data symbols obtained from the one or more resource blocks in the first resource block set, and decoding the second data symbols prior to decoding third data symbols obtained from the one or more resource blocks in the second guard band.

In some examples, the decoding component 935 is capable of, configured to, or operable to support a means for decoding the data message based on receiving the data message, where the second guard band is lower in frequency than the first resource block set, and where decoding the data message includes decoding first data symbols of the data message obtained from the one or more resource blocks in the first resource block set prior to decoding second data symbols obtained from the one or more resource blocks in the guard band, and decoding the second data symbols prior to decoding third data symbols obtained from the one or more resource blocks in the second guard band.

In some examples, at least a portion of the second resource block set is allocated to a second data channel.

In some examples, one or more pairs of proximal resource block sets within the set of multiple resource block sets are separated in frequency from one another by respective guard bands.

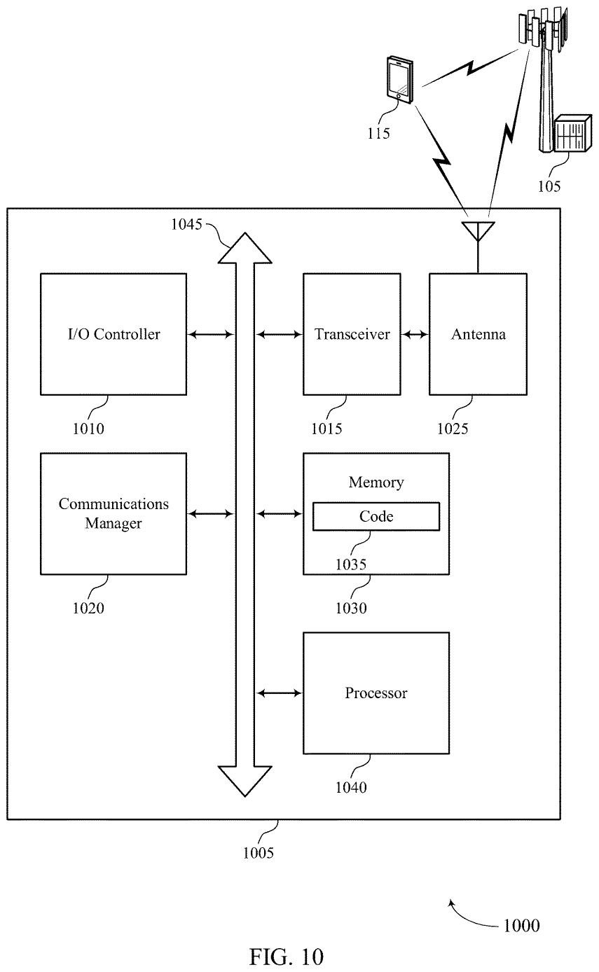

FIG. 10 shows a diagram of a system 1000 including a device 1005 that supports guard band utilization for sidelink communications in accordance with one or more aspects of the present disclosure. The device 1005 may be an example of or include the components of a device 705, a device 805, as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable code 1035 including instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may contain, among other things, a basic I/O system (BIOS) which may control basic hardware or software operation such as the interaction with peripheral components or devices.

The at least one processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting guard band utilization for sidelink communications). For example, the device 1005 or a component of the device 1005 may include at least one processor 1040 and at least one memory 1030 coupled with or to the at least one processor 1040, the at least one processor 1040 and at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions herein.

The communications manager 1020 may support wireless communications in accordance with examples as disclosed herein. For example, the communications manager 1020 is capable of, configured to, or operable to support a means for receiving, using a first resource block set of a set of multiple resource block sets in an unlicensed sidelink band, a control message for the first UE, the control message indicating that at least a portion of the first resource block set and at least a portion of a guard band have been allocated to a data channel, where the guard band is positioned in frequency between a first frequency range of the first resource block set and a second frequency range of a second resource block set of the set of multiple resource block sets. The communications manager 1020 is capable of, configured to, or operable to support a means for receiving, based on the control message, a data message using resource blocks in the first resource block set and resource blocks in the guard band, the resource blocks in the first resource block set and the resource blocks in the guard band corresponding to an interlace indicated in the control message and selected from a set of multiple interlaces.

By including or configuring the communications manager 1020 in accordance with examples as described herein, the device 1005 may support techniques for more efficiently using SL-U resource by utilizing guard band resources in obtained SL-U resources.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of guard band utilization for sidelink communications as described herein, or the at least one processor 1040 and the at least one memory 1030 may be otherwise configured to, individually or collectively, perform or support such operations.

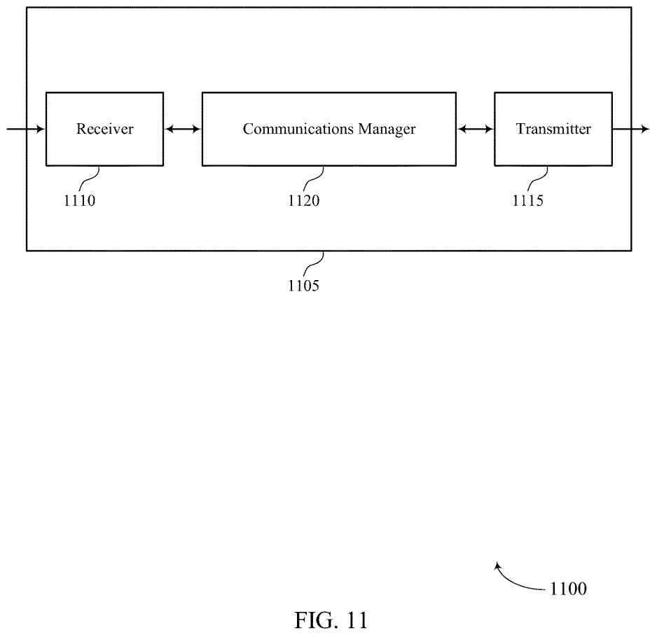

FIG. 11 shows a block diagram 1100 of a device 1105 that supports guard band utilization for sidelink communications in accordance with one or more aspects of the present disclosure. The device 1105 may be an example of aspects of a network entity 105 or UE 115 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of guard band utilization for sidelink communications as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor. If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for allocating, to a data channel, at least a portion of a first resource block set of a set of multiple resource block sets in an unlicensed sidelink band and at least a portion of a guard band based on obtaining access to at least a portion of the unlicensed sidelink band that includes the first resource block set, where the guard band is positioned in frequency between a first frequency range of the first resource block set and a second frequency range of a second resource block set of the set of multiple resource block sets. The communications manager 1120 is capable of, configured to, or operable to support a means for transmitting, based on the allocating, using the first resource block set, a control message for a second UE, the control message indicating that at least the portion of the first resource block set and at least the portion of the guard band have been allocated to the data channel, where resource blocks in the portion of the first resource block set and resource blocks in the portion of the guard band correspond to an interlace indicated in the control message and selected from a set of multiple interlaces.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for more efficiently using SL-U resource by utilizing guard band resources in obtained SL-U resources.

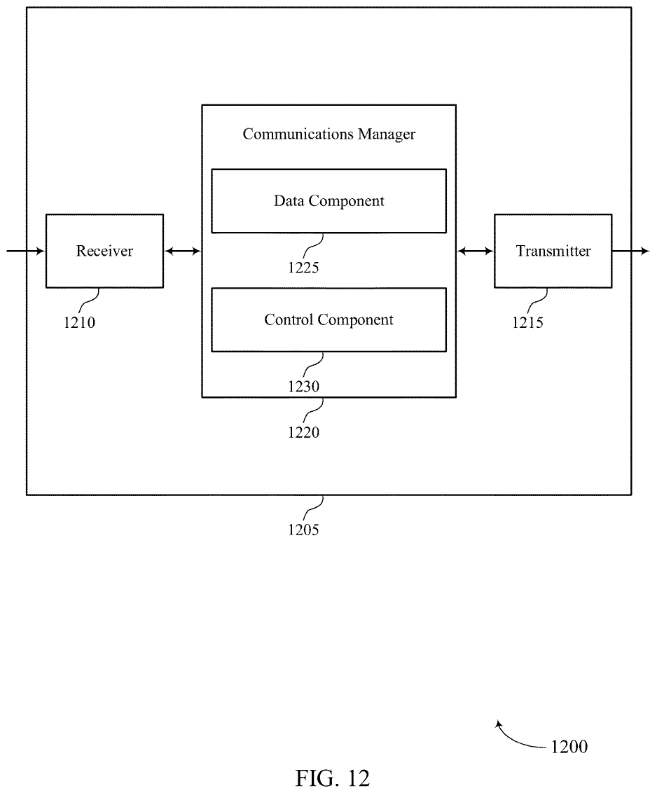

FIG. 12 shows a block diagram 1200 of a device 1205 that supports guard band utilization for sidelink communications in accordance with one or more aspects of the present disclosure. The device 1205 may be an example of aspects of a device 1105 as described herein. The device 1205 may include a receiver 1210, a transmitter 1215, and a communications manager 1220. The device 1205, or one of more components of the device 1205 (e.g., the receiver 1210, the transmitter 1215, and the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of guard band utilization for sidelink communications as described herein. For example, the communications manager 1220 may include a data component 1225 a control component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The data component 1225 is capable of, configured to, or operable to support a means for allocating, to a data channel, at least a portion of a first resource block set of a set of multiple resource block sets in an unlicensed sidelink band and at least a portion of a guard band based on obtaining access to at least a portion of the unlicensed sidelink band that includes the first resource block set, where the guard band is positioned in frequency between a first frequency range of the first resource block set and a second frequency range of a second resource block set of the set of multiple resource block sets. The control component 1230 is capable of, configured to, or operable to support a means for transmitting, based on the allocating, using the first resource block set, a control message for a second UE, the control message indicating that at least the portion of the first resource block set and at least the portion of the guard band have been allocated to the data channel, where resource blocks in the portion of the first resource block set and resource blocks in the portion of the guard band correspond to an interlace indicated in the control message and selected from a set of multiple interlaces.

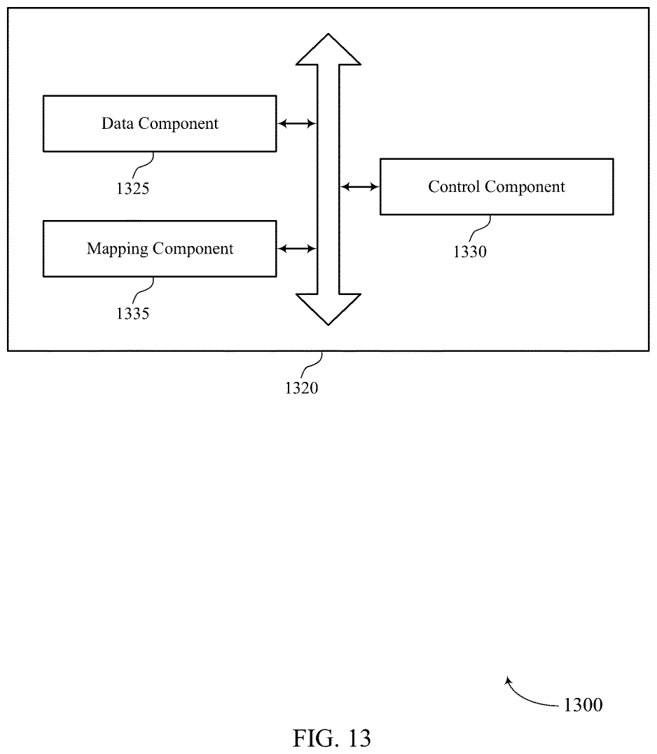

FIG. 13 shows a block diagram 1300 of a communications manager 1320 that supports guard band utilization for sidelink communications in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of guard band utilization for sidelink communications as described herein. For example, the communications manager 1320 may include a data component 1325, a control component 1330, a mapping component 1335, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The data component 1325 is capable of, configured to, or operable to support a means for allocating, to a data channel, at least a portion of a first resource block set of a set of multiple resource block sets in an unlicensed sidelink band and at least a portion of a guard band based on obtaining access to at least a portion of the unlicensed sidelink band that includes the first resource block set, where the guard band is positioned in frequency between a first frequency range of the first resource block set and a second frequency range of a second resource block set of the set of multiple resource block sets. The control component 1330 is capable of, configured to, or operable to support a means for transmitting, based on the allocating, using the first resource block set, a control message for a second UE, the control message indicating that at least the portion of the first resource block set and at least the portion of the guard band have been allocated to the data channel, where resource blocks in the portion of the first resource block set and resource blocks in the portion of the guard band correspond to an interlace indicated in the control message and selected from a set of multiple interlaces.

In some examples, the data component 1325 is capable of, configured to, or operable to support a means for scheduling, based on obtaining the access, the data channel for at least the portion of the first resource block set and a second data channel for at least a portion of the second resource block set.

In some examples, at least the portion of the guard band is allocated to the data channel based on at least the portion of the first resource block set and at least the portion of the second resource block set both being obtained by the first UE.

In some examples, the control message indicates that at least the portion of the guard band has been allocated to the data channel based on the guard band being higher in frequency than the first resource block set.

In some examples, the control message indicates that at least the portion of the first resource block set has been allocated to the data channel based on being transmitted using the first resource block set.

In some examples, the control message further indicates an interlace index corresponding to the interlace and a subchannel of the data channel, and one or more resource blocks in the first resource block set corresponding to the subchannel of the data channel and one or more resource blocks in the guard band assigned the interlace index corresponding to the subchannel of the data channel are allocated to the data channel.

In some examples, the data component 1325 is capable of, configured to, or operable to support a means for transmitting a data message for the second UE using the one or more resource blocks in the first resource block set and the one or more resource blocks in the guard band.

In some examples, a second guard band is positioned in frequency between the first resource block set and a third resource block set of the set of multiple resource block sets, the first resource block set positioned in frequency between the second resource block set and the third resource block set, and the control message further indicates whether at least a portion of the second guard band has been allocated to the data channel.

In some examples, the control message further indicates an interlace index corresponding to the interlace and a subchannel of the data channel, and one or more resource blocks in the first resource block set corresponding to the subchannel of the data channel, one or more resource blocks in the guard band assigned the interlace index corresponding to the subchannel, and one or more resource blocks in the second guard band assigned the interlace index are allocated to the subchannel of the data channel.

In some examples, the control message indicates that at least the portion of the guard band and at least the portion of the second guard band have been allocated to the data channel, and the data component 1325 is capable of, configured to, or operable to support a means for transmitting a data message for the second UE using one or more resource blocks in the second guard band, one or more resource blocks in the first resource block set, and one or more resource blocks in the guard band.

In some examples, the control message indicates that at least the portion of the guard band and at least the portion of the second guard band have been allocated to the data channel, and the mapping component 1335 is capable of, configured to, or operable to support a means for mapping first data symbols of a data message for the second UE to one or more resource blocks in the first resource block set, second data symbols of the data message to one or more resource blocks in the guard band, and third data symbols of the data message to one or more resource blocks in the second guard band, where the second guard band is lower in frequency than the first resource block set.

In some examples, the first data symbols mapped to the one or more resource blocks in the first resource block set are to be decoded prior to the second data symbols mapped to the one or more resource blocks in the guard band being decoded, and the second data symbols are to be decoded prior to the third data symbols mapped to the one or more resource blocks in the second guard band being decoded.

In some examples, the control message indicates that at least the portion of the guard band and at least the portion of the second guard band have been allocated to the data channel, and the mapping component 1335 is capable of, configured to, or operable to support a means for mapping first data symbols of a data message for the second UE to one or more resource blocks in the second guard band, second data symbols of the data message to one or more resource blocks in the first resource block set, and third data symbols of the data message to one or more resource blocks in the guard band, where the second guard band is lower in frequency than the first resource block set.

In some examples, the first data symbols mapped to the one or more resource blocks in the second guard band are to be decoded prior to the second data symbols mapped to the one or more resource blocks in the first resource block set being decoded, and the second data symbols are to be decoded prior to the third data symbols mapped to the one or more resource blocks in the guard band being decoded.

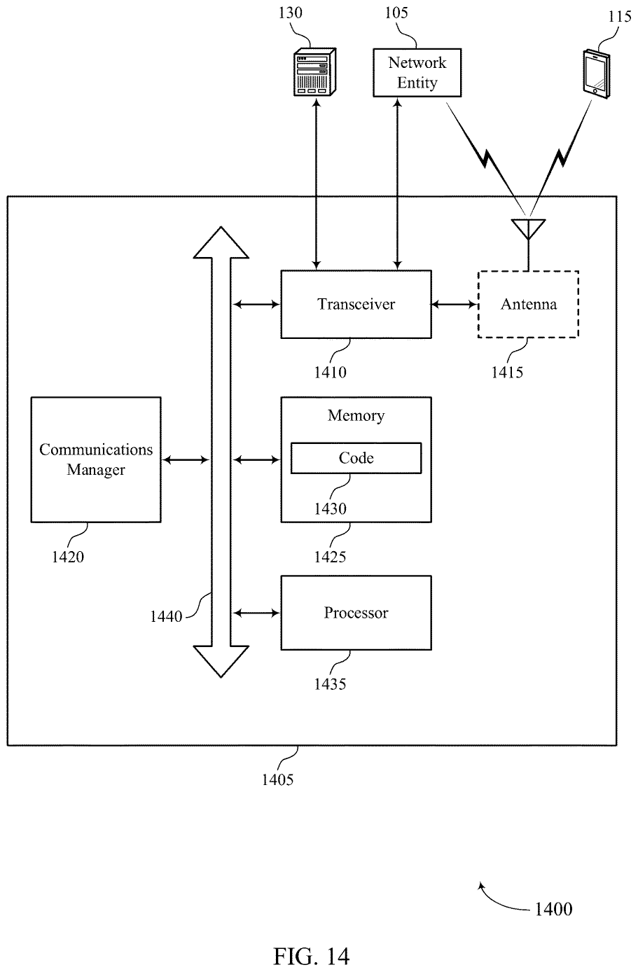

FIG. 14 shows a diagram of a system 1400 including a device 1405 that supports guard band utilization for sidelink communications in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., a communication link 125, a backhaul communication link 120, a midhaul communication link 162, a fronthaul communication link 168).

The at least one memory 1425 may include RAM, ROM, or any combination thereof. The at least one memory 1425 may store computer-readable, computer-executable code 1430 including instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may contain, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting guard band utilization for sidelink communications). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425). In some implementations, the at least one processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the at least one processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105 and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for allocating, to a data channel, at least a portion of a first resource block set of a set of multiple resource block sets in an unlicensed sidelink band and at least a portion of a guard band based on obtaining access to at least a portion of the unlicensed sidelink band that includes the first resource block set, where the guard band is positioned in frequency between a first frequency range of the first resource block set and a second frequency range of a second resource block set of the set of multiple resource block sets. The communications manager 1420 is capable of, configured to, or operable to support a means for transmitting, based on the allocating, using the first resource block set, a control message for a second UE, the control message indicating that at least the portion of the first resource block set and at least the portion of the guard band have been allocated to the data channel, where resource blocks in the portion of the first resource block set and resource blocks in the portion of the guard band correspond to an interlace indicated in the control message and selected from a set of multiple interlaces.

By including or configuring the communications manager 1420 in accordance with examples as described herein, the device 1405 may support techniques for more efficiently using SL-U resource by utilizing guard band resources in obtained SL-U resources.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of guard band utilization for sidelink communications as described herein, or the at least one processor 1435 and the at least one memory 1425 may be otherwise configured to, individually or collectively, perform or support such operations.

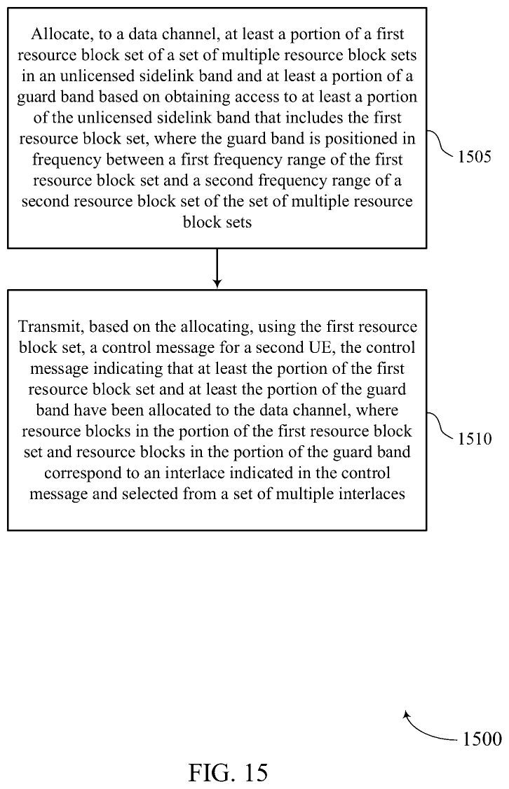

FIG. 15 shows a flowchart illustrating a method 1500 that supports guard band utilization for sidelink communications in accordance with aspects of the present disclosure. The operations of the method 1500 may be implemented by a UE, a network entity or its components as described herein. For example, the operations of the method 1500 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1505, the method may include allocating, to a data channel, at least a portion of a first resource block set of a set of multiple resource block sets in an unlicensed sidelink band and at least a portion of a guard band based on obtaining access to at least a portion of the unlicensed sidelink band that includes the first resource block set, where the guard band is positioned in frequency between a first frequency range of the first resource block set and a second frequency range of a second resource block set of the set of multiple resource block sets. The operations of block 1505 may be performed in accordance with examples as disclosed herein. In some examples, aspects of the operations of 1505 may be performed by a data component 1325 as described with reference to FIG. 13.

At 1510, the method may include transmitting, based on the allocating, using the first resource block set, a control message for a second UE, the control message indicating that at least the portion of the first resource block set and at least the portion of the guard band have been allocated to the data channel, where resource blocks in the portion of the first resource block set and resource blocks in the portion of the guard band correspond to an interlace indicated in the control message and selected from a set of multiple interlaces. The operations of block 1510 may be performed in accordance with examples as disclosed herein. In some examples, aspects of the operations of 1510 may be performed by a control component 1330 as described with reference to FIG. 13.

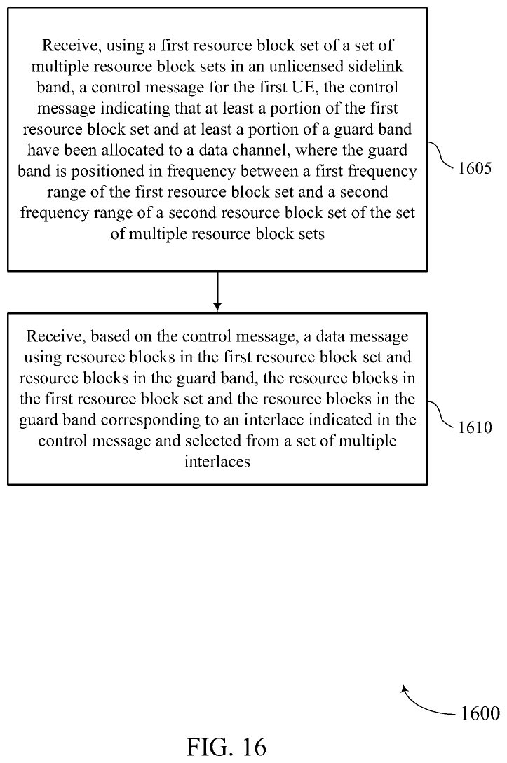

FIG. 16 shows a flowchart illustrating a method 1600 that supports guard band utilization for sidelink communications in accordance with aspects of the present disclosure. The operations of the method 1600 may be implemented by a UE, a network entity or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving, using a first resource block set of a set of multiple resource block sets in an unlicensed sidelink band, a control message for the first UE, the control message indicating that at least a portion of the first resource block set and at least a portion of a guard band have been allocated to a data channel, where the guard band is positioned in frequency between a first frequency range of the first resource block set and a second frequency range of a second resource block set of the set of multiple resource block sets. The operations of block 1605 may be performed in accordance with examples as disclosed herein. In some examples, aspects of the operations of 1605 may be performed by a control component 925 as described with reference to FIG. 9.

At 1610, the method may include receiving, based on the control message, a data message using resource blocks in the first resource block set and resource blocks in the guard band, the resource blocks in the first resource block set and the resource blocks in the guard band corresponding to an interlace indicated in the control message and selected from a set of multiple interlaces. The operations of block 1610 may be performed in accordance with examples as disclosed herein. In some examples, aspects of the operations of 1610 may be performed by a data component 930 as described with reference to FIG. 9.

The following provides an overview of aspects of the present disclosure:
Aspect 1: A method for wireless communications at a first user equipment (UE), comprising: allocating, to a data channel, at least a portion of a first resource block set of a plurality of resource block sets in an unlicensed sidelink band and at least a portion of a guard band based at least in part on obtaining access to at least a portion of the unlicensed sidelink band that comprises the first resource block set, wherein the guard band is positioned in frequency between a first frequency range of the first resource block set and a second frequency range of a second resource block set of the plurality of resource block sets; and transmitting, based at least in part on the allocating, using the first resource block set, a control message for a second UE, the control message indicating that at least the portion of the first resource block set and at least the portion of the guard band have been allocated to the data channel, wherein resource blocks in the portion of the first resource block set and resource blocks in the portion of the guard band correspond to an interlace indicated in the control message and selected from a plurality of interlaces.
Aspect 2: The method of aspect 1, further comprising: scheduling, based at least in part on obtaining the access, the data channel for at least the portion of the first resource block set and a second data channel for at least a portion of the second resource block set.
Aspect 3: The method of aspect 2, wherein at least the portion of the guard band is allocated to the data channel based at least in part on at least the portion of the first resource block set and at least the portion of the second resource block set both being obtained by the first UE.
Aspect 4: The method of any of aspects 1 through 3, wherein the control message indicates that at least the portion of the guard band has been allocated to the data channel based at least in part on the guard band being higher in frequency than the first resource block set.
Aspect 5: The method of any of aspects 1 through 4, wherein the control message indicates that at least the portion of the first resource block set has been allocated to the data channel based at least in part on being transmitted using the first resource block set.
Aspect 6: The method of any of aspects 1 through 5, wherein the control message further indicates an interlace index corresponding to the interlace and a subchannel of the data channel, and one or more resource blocks in the first resource block set corresponding to the subchannel of the data channel and one or more resource blocks in the guard band assigned the interlace index corresponding to the subchannel of the data channel are allocated to the data channel.
Aspect 7: The method of aspect 6, further comprising: transmitting a data message for the second UE using the one or more resource blocks in the first resource block set and the one or more resource blocks in the guard band.
Aspect 8: The method of aspect 1, wherein a second guard band is positioned in frequency between the first resource block set and a third resource block set of the plurality of resource block sets, the first resource block set positioned in frequency between the second resource block set and the third resource block set, and the control message further indicates whether at least a portion of the second guard band has been allocated to the data channel.
Aspect 9: The method of aspect 8, wherein the control message further indicates an interlace index corresponding to the interlace and a subchannel of the data channel, and one or more resource blocks in the first resource block set corresponding to the subchannel of the data channel, one or more resource blocks in the guard band assigned the interlace index corresponding to the subchannel, and one or more resource blocks in the second guard band assigned the interlace index are allocated to the subchannel of the data channel.
Aspect 10: The method of any of aspects 8 through 9, wherein the control message indicates that at least the portion of the guard band and at least the portion of the second guard band have been allocated to the data channel, the method further comprising: transmitting a data message for the second UE using one or more resource blocks in the second guard band, one or more resource blocks in the first resource block set, and one or more resource blocks in the guard band.
Aspect 11: The method of any of aspects 8 through 10, wherein the control message indicates that at least the portion of the guard band and at least the portion of the second guard band have been allocated to the data channel, the method further comprising: mapping first data symbols of a data message for the second UE to one or more resource blocks in the first resource block set, second data symbols of the data message to one or more resource blocks in the guard band, and third data symbols of the data message to one or more resource blocks in the second guard band, wherein the second guard band is lower in frequency than the first resource block set.
Aspect 12: The method of aspect 11, wherein the first data symbols mapped to the one or more resource blocks in the first resource block set are to be decoded prior to the second data symbols mapped to the one or more resource blocks in the guard band being decoded, and the second data symbols are to be decoded prior to the third data symbols mapped to the one or more resource blocks in the second guard band being decoded.
Aspect 13: The method of any of aspects 8 through 12, wherein the control message indicates that at least the portion of the guard band and at least the portion of the second guard band have been allocated to the data channel, the method further comprising: mapping first data symbols of a data message for the second UE to one or more resource blocks in the second guard band, second data symbols of the data message to one or more resource blocks in the first resource block set, and third data symbols of the data message to one or more resource blocks in the guard band, wherein the second guard band is lower in frequency than the first resource block set.
Aspect 14: The method of aspect 13, wherein the first data symbols mapped to the one or more resource blocks in the second guard band are to be decoded prior to the second data symbols mapped to the one or more resource blocks in the first resource block set being decoded, and the second data symbols are to be decoded prior to the third data symbols mapped to the one or more resource blocks in the guard band being decoded.
Aspect 15: A method for wireless communications at a first UE, comprising: receiving, using a first resource block set of a plurality of resource block sets in an unlicensed sidelink band, a control message for the first UE, the control message indicating that at least a portion of the first resource block set and at least a portion of a guard band have been allocated to a data channel, wherein the guard band is positioned in frequency between a first frequency range of the first resource block set and a second frequency range of a second resource block set of the plurality of resource block sets; and receiving, based at least in part on the control message, a data message using resource blocks in the first resource block set and resource blocks in the guard band, the resource blocks in the first resource block set and the resource blocks in the guard band corresponding to an interlace indicated in the control message and selected from a plurality of interlaces.
Aspect 16: The method of aspect 15, further comprising: determining, based at least in part on the control message indicating that at least the portion of the guard band has been allocated to the data channel, that the guard band is higher in frequency than a frequency within which the control message is received.
Aspect 17: The method of any of aspects 15 through 16, further comprising: determining that at least the portion of the first resource block set has been allocated to the data channel based at least in part on the control message being transmitted using the first resource block set.
Aspect 18: The method of any of aspects 15 through 17, further comprising: obtaining, from the control message, an interlace index corresponding to the interlace and a subchannel of the data channel; and identifying one or more resource blocks in the first resource block set and one or more resource blocks in the guard band based at least in part on the interlace index, wherein the subchannel of the data channel comprises the one or more identified resource blocks in the first resource block set.
Aspect 19: The method of aspect 15, wherein the control message further indicates that at least a portion of a second guard band has been allocated to the data channel, the second guard band is positioned in frequency between the first resource block set and a third resource block set of the plurality of resource block sets, the first resource block set positioned in frequency between the second resource block set and the third resource block set.
Aspect 20: The method of aspect 19, further comprising: obtaining, from the control message, an interlace index corresponding to the interlace and a subchannel of the data channel; and identifying one or more resource blocks in the first resource block set, one or more resource blocks in the guard band, and one or more resource blocks in the second resource block set based at least in part on the interlace index, wherein the one or more resource blocks comprises the one or more identified resource blocks in the first resource block set corresponding to the subchannel, the one or more identified resource blocks in the guard band, and the one or more identified resource blocks in the second guard band.
Aspect 21: The method of any of aspects 19 through 20, wherein receiving the data message comprises receiving the data message using one or more resource blocks in the first resource block set, one or more resource blocks in the guard band, and one or more resource blocks in the second guard band.
Aspect 22: The method of aspect 21, further comprising: decoding the data message based at least in part on receiving the data message, wherein the second guard band is lower in frequency than the first resource block set, and wherein decoding the data message comprises decoding first data symbols of the data message obtained from the one or more resource blocks in the second guard band prior to decoding second data symbols obtained from the one or more resource blocks in the first resource block set, and decoding the second data symbols prior to decoding third data symbols obtained from the one or more resource blocks in the second guard band.
Aspect 23: The method of any of aspects 21 through 22, further comprising: decoding the data message based at least in part on receiving the data message, wherein the second guard band is lower in frequency than the first resource block set, and wherein decoding the data message comprises decoding first data symbols of the data message obtained from the one or more resource blocks in the first resource block set prior to decoding second data symbols obtained from the one or more resource blocks in the guard band, and decoding the second data symbols prior to decoding third data symbols obtained from the one or more resource blocks in the second guard band.
Aspect 24: The method of any of aspects 15 through 23, wherein at least a portion of the second resource block set is allocated to a second data channel.
Aspect 25: The method of any of aspects 15 through 24, wherein one or more pairs of proximal resource block sets within the plurality of resource block sets are separated in frequency from one another by respective guard bands.
Aspect 26: A first UE for wireless communications, comprising one or more memories storing processor-executable code, and one or more processors coupled with the one or more memories and individually or collectively operable to execute the code to cause the first UE to perform a method of any of aspects 1 through 14.
Aspect 27: A first UE for wireless communications, comprising at least one means for performing a method of any of aspects 1 through 14.
Aspect 28: A non-transitory computer-readable medium storing code for wireless communications, the code comprising instructions executable by a processor to perform a method of any of aspects 1 through 14.
Aspect 29: A first UE for wireless communications, comprising one or more memories storing processor-executable code, and one or more processors coupled with the one or more memories and individually or collectively operable to execute the code to cause the first UE to perform a method of any of aspects 15 through 25.
Aspect 30: A first UE for wireless communications, comprising at least one means for performing a method of any of aspects 15 through 25.
Aspect 31: A non-transitory computer-readable medium storing code for wireless communications, the code comprising instructions executable by a processor to perform a method of any of aspects 15 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

Also, as used herein, the phrase “a set” shall be construed as including the possibility of a set with one member. That is, the phrase “a set” shall be construed in the same manner as “one or more.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A first user equipment (UE) for wireless communications, comprising:
one or more memories storing processor-executable code; and
one or more processors coupled with the one or more memories and individually or collectively operable to execute the code to cause the first UE to:
allocate, to a data channel, at least a portion of a first resource block set of a plurality of resource block sets in an unlicensed sidelink band and at least a portion of a guard band based at least in part on obtaining access to at least a portion of the unlicensed sidelink band that comprises the first resource block set, wherein the guard band is positioned in frequency between a first frequency range of the first resource block set and a second frequency range of a second resource block set of the plurality of resource block sets; and
transmit, based at least in part on the allocating, using the first resource block set, a control message for a second UE, the control message indicating that at least the portion of the first resource block set and at least the portion of the guard band have been allocated to the data channel, wherein resource blocks in the portion of the first resource block set and resource blocks in the portion of the guard band correspond to an interlace indicated in the control message and selected from a plurality of interlaces.

2. The first UE of claim 1, wherein the one or more processors are individually or collectively operable to execute the code to cause the first UE to:
schedule, based at least in part on obtaining the access, the data channel for at least the portion of the first resource block set and a second data channel for at least a portion of the second resource block set.

3. The first UE of claim 2, wherein at least the portion of the guard band is allocated to the data channel based at least in part on at least the portion of the first resource block set and at least the portion of the second resource block set both being obtained by the first UE.

4. The first UE of claim 1, wherein the control message indicates that at least the portion of the guard band has been allocated to the data channel based at least in part on the guard band being higher in frequency than the first resource block set.

5. The first UE of claim 1, wherein the control message indicates that at least the portion of the first resource block set has been allocated to the data channel based at least in part on being transmitted using the first resource block set.

6. The first UE of claim 1, wherein:
the control message further indicates an interlace index corresponding to the interlace and a subchannel of the data channel, and
one or more resource blocks in the first resource block set corresponding to the subchannel of the data channel and one or more resource blocks in the guard band assigned the interlace index corresponding to the subchannel of the data channel are allocated to the data channel.

7. The first UE of claim 6, wherein the one or more processors are individually or collectively operable to execute the code to cause the first UE to:
transmit a data message for the second UE using the one or more resource blocks in the first resource block set and the one or more resource blocks in the guard band.

8. The first UE of claim 1, wherein:
a second guard band is positioned in frequency between the first resource block set and a third resource block set of the plurality of resource block sets, the first resource block set positioned in frequency between the second resource block set and the third resource block set, and
the control message further indicates whether at least a portion of the second guard band has been allocated to the data channel.

9. The first UE of claim 8, wherein:
the control message further indicates an interlace index corresponding to the interlace and a subchannel of the data channel, and
one or more resource blocks in the first resource block set corresponding to the subchannel of the data channel, one or more resource blocks in the guard band assigned the interlace index corresponding to the subchannel, and one or more resource blocks in the second guard band assigned the interlace index are allocated to the subchannel of the data channel.

10. The first UE of claim 8, wherein the control message indicates that at least the portion of the guard band and at least the portion of the second guard band have been allocated to the data channel, and wherein the one or more processors are individually or collectively operable to execute the code to cause the first UE to:
transmit a data message for the second UE using one or more resource blocks in the second guard band, one or more resource blocks in the first resource block set, and one or more resource blocks in the guard band.

11. The first UE of claim 8, wherein the control message indicates that at least the portion of the guard band and at least the portion of the second guard band have been allocated to the data channel, and wherein the one or more processors are individually or collectively operable to execute the code to cause the first UE to:
map first data symbols of a data message for the second UE to one or more resource blocks in the first resource block set, second data symbols of the data message to one or more resource blocks in the guard band, and third data symbols of the data message to one or more resource blocks in the second guard band, wherein the second guard band is lower in frequency than the first resource block set.

12. The first UE of claim 11, wherein the first data symbols mapped to the one or more resource blocks in the first resource block set are to be decoded prior to the second data symbols mapped to the one or more resource blocks in the guard band being decoded, and the second data symbols are to be decoded prior to the third data symbols mapped to the one or more resource blocks in the second guard band being decoded.

13. The first UE of claim 8, wherein the control message indicates that at least the portion of the guard band and at least the portion of the second guard band have been allocated to the data channel, and wherein the one or more processors are individually or collectively operable to execute the code to cause the first UE to:
map first data symbols of a data message for the second UE to one or more resource blocks in the second guard band, second data symbols of the data message to one or more resource blocks in the first resource block set, and third data symbols of the data message to one or more resource blocks in the guard band, wherein the second guard band is lower in frequency than the first resource block set.

14. The first UE of claim 13, wherein the first data symbols mapped to the one or more resource blocks in the second guard band are to be decoded prior to the second data symbols mapped to the one or more resource blocks in the first resource block set being decoded, and the second data symbols are to be decoded prior to the third data symbols mapped to the one or more resource blocks in the guard band being decoded.

15. A first user equipment (UE) for wireless communications, comprising:
one or more memories storing processor-executable code; and
one or more processors coupled with the one or more memories and individually or collectively operable to execute the code to cause the first UE to:
receive, using a first resource block set of a plurality of resource block sets in an unlicensed sidelink band, a control message for the first UE, the control message indicating that at least a portion of the first resource block set and at least a portion of a guard band have been allocated to a data channel, wherein the guard band is positioned in frequency between a first frequency range of the first resource block set and a second frequency range of a second resource block set of the plurality of resource block sets; and
receive, based at least in part on the control message, a data message using resource blocks in the first resource block set and resource blocks in the guard band, the resource blocks in the first resource block set and the resource blocks in the guard band corresponding to an interlace indicated in the control message and selected from a plurality of interlaces.

16. The first UE of claim 15, wherein the one or more processors are individually or collectively operable to execute the code to cause the first UE to:
determine, based at least in part on the control message indicating that at least the portion of the guard band has been allocated to the data channel, that the guard band is higher in frequency than a frequency within which the control message is received.

17. The first UE of claim 15, wherein the one or more processors are individually or collectively operable to execute the code to cause the first UE to:
determine that at least the portion of the first resource block set has been allocated to the data channel based at least in part on the control message being transmitted using the first resource block set.

18. The first UE of claim 15, wherein the one or more processors are individually or collectively operable to execute the code to cause the first UE to:
obtain, from the control message, an interlace index corresponding to the interlace and a subchannel of the data channel; and
identify one or more resource blocks in the first resource block set and one or more resource blocks in the guard band based at least in part on the interlace index, wherein the subchannel of the data channel comprises the one or more identified resource blocks in the first resource block set.

19. The first UE of claim 15, wherein:
the control message further indicates that at least a portion of a second guard band has been allocated to the data channel, wherein the second guard band is positioned in frequency between the first resource block set and a third resource block set of the plurality of resource block sets, the first resource block set positioned in frequency between the second resource block set and the third resource block set.

20-25. (canceled)

26. A method for wireless communications by a first UE, comprising:
allocating, to a data channel, at least a portion of a first resource block set of a plurality of resource block sets in an unlicensed sidelink band and at least a portion of a guard band based at least in part on obtaining access to at least a portion of the unlicensed sidelink band that comprises the first resource block set, wherein the guard band is positioned in frequency between a first frequency range of the first resource block set and a second frequency range of a second resource block set of the plurality of resource block sets; and
transmitting, based at least in part on the allocating, using the first resource block set, a control message for a second UE, the control message indicating that at least the portion of the first resource block set and at least the portion of the guard band have been allocated to the data channel, wherein resource blocks in the portion of the first resource block set and resource blocks in the portion of the guard band correspond to an interlace indicated in the control message and selected from a plurality of interlaces.

27-30. (canceled)
